(19) United States
(12) Patent Application Publication
(10) Pub. No.: US 2005/0058745 A1
(43) Pub. Date: Mar. 17, 2005

(54) Use of Labiatae herb preparations for extending the flavor shelf life of malt beverages

(76) Inventors: Randall H. Mennett, Portage, MI (US); James P. Barren, Kalamazoo, MI (US); Donald R. Berdahl, Lawton, MI (US); Paul H. Todd JR., Kalamazoo, MI (US); Michael C. Babb, Kalamazoo, MI (US)

Correspondence Address: THE FIRM OF HUESCHEN AND SAGE, 500 COLUMBIA PLAZA, 350 EAST MICHIGAN AVENUE, KALAMAZOO, MI, 49007, US

(21) Appl. No.: 10/939,308

(22) Filed: Sep. 10, 2004

Related U.S. Application Data
(60) Provisional application No. 60/502,512, filed on Sep. 12, 2003.

(51) Int. Cl. C12C 11/00

(52) U.S. Cl. 426/11

(57) ABSTRACT

The present invention is concerned with a method for enhancing the flavor shelf life of beverages, including beer and other malt beverages, by incorporating Labiatae herb extracts either to the finished beverage or into a step in the manufacture of the beverage.

### FIELD OF THE INVENTION

The present invention is concerned with a method for enhancing the flavor shelf life of beverages, including beer and other malt beverages, by incorporating Labiatae herb extracts either to the finshed beverage or into a step in the manufacture of the beverage.

### BACKGROUND OF THE INVENTION

Fresh beer flavor is very unstable and deteriorates from the time it is newly brewed through packaging and until the time it is consumed. The higher the temperature a beer is exposed to during distribution or storage, the faster the flavor deteriorates. In tropical or desert climates, where storage temperatures can easily reach 40-50° C. (104-122° F.), the flavor of beer can be seriously affected in a day or two. Even in temperate climates, temperature excursions can occur. Consequently, the shelf life of beers is measured in weeks and not months.

In this application, the term “beer” is used according to the definition in 27 CFR Subpart B, Section 25.11, namely:
“beer, ale, porter, stout, and other similar fermented beverages (including sake or similar products) of any name or description containing one-half of one percent or more of alcohol by volume, brewed or produced from malt, wholly or in part, or from any substitute for malt.”

Malt beverages are defined as in 27 CFR Subpart B Section 7.10, namely:
“A beverage made by the alcoholic fermentation of an infusion or decoction, or combination of both, in potable brewing water, of malted barley with hops, or their parts, or their products, and with or without other malted cereals, and with or without the addition of unmalted or prepared cereals, other carbohydrates or products prepared therefrom, and with or without the addition of carbon dioxide, and with or without other wholesome products suitable for human food consumption.”

Flavored malt beverages are held to be distinctly different from beer and from malt beverages, in general, and are treated separately. Flavored malt beverages are defined and recognized as distinct from other malt beverages as described in a notice to proposed rulemaking, Federal Register/Vol. 68, No. 56/Monday, Mar. 24, 2003:
“Although flavored malt beverages are produced at breweries, their method of production differs significantly from the production of other malt beverages or beer. In producing flavored malt beverages, brewers brew a fermented base of beer from malt and other brewing material. Brewers then treat this base using a variety of processes in order to remove malt beverage character from the base; i.e., they remove the color, bitterness and taste that are generally associated with beer, ale porter, stout and other malt beverages. This leaves a base product to which brewers add various flavors, which typically contain distilled spirits, to achieve the desired taste profile and alcohol level.”

For this application, the term “malt beverages” includes such foam-forming, fermented malt beverages as beer, ale, dry beer, near beer, light beer, low alcohol beer, low calorie beer, porter, bock beer, stout, malt liquor, non-alcoholic malt beverages, beers from which alcohol has been removed and the like. Unless otherwise noted, the term “beer” shall be used throughout this specification as a generic term and refers to the entire group of fermented malt beverages, but not flavored malt beverages.

Breweries have tried to solve the flavor stability problem in a number of ways as ably summarized in a review article by Bamforth [2000]:

| | |
|---|---|
| 1. | By reducing temperature of transport |
| | and storage of the finished beer - a |
| | very expensive step, impractical in developing countries. |
| 2. | By reducing the contact between brewing |
| | materials and oxygen at various |
| | stages in the brewing process. |
| 3. | By selecting barley with low lipoxygenase activity. |
| 4. | By maximizing kilning temperatures. |
| 5. | By increasing use of sugar adjuncts and |
| | colored malts (high polyphenolic content) |
| 6. | By using anaerobic milling. |
| 7. | By avoiding excessively long heating cycles during wort boil. |
| 8. | By using yeast varieties that enhance sulfur |
| | dioxide levels in the finished product. |
| 9. | By using oxygen scavenging crown liners. |
| 10. | By using reduced iso-alpha-acids. |
| 11. | By increasing effectiveness of stock |
| | rotation in the distribution system. |
| 12. | By adding ascorbic acid. |

Beer contains a complex mixture of ingredients. Some of the compounds naturally present in beer provide an “oxidation buffer” of sorts by serving as endogenous antioxidants. An antioxidant is a material that slows the progress of an oxidation reaction. Some antioxidants function by acting as sacrificial substances that undergo oxidation more readily than the substrate they protect. To be effective, their oxidation products need to be innocuous and unlikely to become involved in further oxidation reactions. Since oxidation and reduction reactions are coupled, these antioxidants function as reducing agents. Brewers routinely obtain an indication of the level of these endogenous antioxidants in beer by measuring what is known variously as the reducing potential, reduction potential, redox potential or reducing activity of a beer. There is general agreement in the industry that the higher the reducing activity or redox potential, the more flavor-stable the beer.

Redox potential can be measured by a number of techniques. In these methods, the beer is challenged with an oxidative insult of one form or another and the response is measured. Treating beer with dichloroindophenol (DCIP) is the basis for one of these tests, and will be the basis for all Redox Potential measurements in this application. A known amount of the dye is added to beer. The endogenous antioxidants reduce an amount of the dye, the amount of which is reduced being measured spectrophotometrically. Another test involves treating beer with the relatively stable free radical, diphenylpicrylhydrazyl (DPPH). The free radical is scavenged by the reducing agents present in beer. Once again, the extent to which the free radical is consumed is measured spectrophotometrically.

There are at least three significant general classes of compounds present in beer that are known to contribute to the reducing activity. These are melanoidins, polyphenols and sulfites. One way to protect the fresh flavor of beer might be to protect these endogenous antioxidant species.

Melanoidins are complex mixtures of chemicals with incompletely defined structures that result from the Maillard reaction between amino acids and reducing sugars. An excellent review of the pro- and antioxidant activity of melanoidins has been published [Ames, 2001].

Polyphenols in beer come from two primary sources, the malt and the hops, and play several complex roles in beer. They contribute to the redox potential, i.e. serve as endogenous antioxidants. They also have been implicated in the formation of chill haze that is another negative manifestation of beer aging. Chill haze occurs when polyphenols are oxidatively polymerized to a sufficiently high molecular weight to form insoluble complexes with certain proteins present in beer. Beers are usually treated with materials such as polyvinylpolypyrollidone (PVPP) and silica gels to remove polyphenols to improve stability in the package.

The one endogenous oxygen scavenger that is clearly important to beer flavor stability is sulfur dioxide. It is produced by yeast during the fermentation process. In some countries, addition of supplemental SO₂ is allowed. At the pHs normally encountered in beer, SO₂ is generally present in the form of sulfites which absorb oxygen to form sulfates. There is also evidence that SO₂ can have a detrimental effect on beer flavor stability. It can serve as a complexing agent with aldehydes during the fermentation process, preventing the conversion of these off-flavor compounds to alcohols and allowing them to be carried over into the finished beer. Since sulfur dioxide is a yeast product and is naturally in beer, it is not enough to prevent staling.

### DESCRIPTION OF THE RELATED ART

Malt Beverages

The issue of preserving the fresh flavor of beer can be divided into two separate, but interrelated problems. The first relates to the protection of those chemical species that are responsible for the organoleptic properties of fresh beer. In a beverage as chemically complicated as beer, a large number of taste and aroma-active constituents exist. Many of the important taste and aroma-active compounds remain to be identified. To prevent organoleptic changes, these materials need to be preserved. Chemical reactions that convert them to other compounds need to be prevented, or at least delayed. The second problem of preserving the fresh flavor of beer is concerned with preventing the production of off-flavor compounds (often called staling compounds) that generate unwanted taste and aroma effects. The generation of foul-tasting aldehydes and ketones from the decomposition of fatty acid hydroperoxides is a well-known example. Of course, in addition to the conversion of a beneficial flavor or aroma-active constituent into a flavor or aroma neutral constituent, an important, beneficial flavor-active compound can be converted into a compound that generates an objectionable off-flavor. Hydrolysis, oxidation, reduction, condensation, Maillard and a host of other chemical reactions are probably involved in one form or another in the overall chemistry of flavor changes in beer.

Oxidation phenomena are generally agreed to play a significant role in the development of off-flavors in beer. There is no consensus on how the oxidation processes in packaged beer occur, or how they can be delayed using the best brewing technology, except by refrigeration.

A very simplified scheme of the brewing process is outlined below.

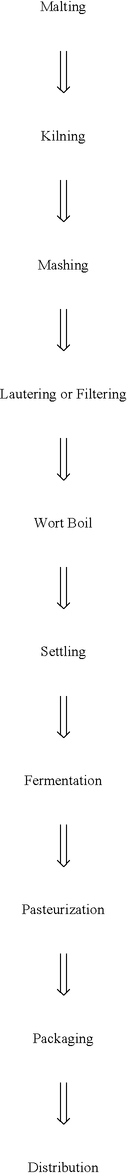

Since the brewing process consists of many steps and can involve a number of ingredients with varying quality and chemical characteristics, the conditions and materials used throughout the brewing process can have a significant impact on the flavor stability of the finished product.

Off-flavor development as a result of oxidation can occur in nearly all of the stages of beer production. When barley is malted, oxygen and active lipoxygenase enzymes convert some of the fatty acids present to hydroperoxides. These compounds are known to break down into a variety of volatile carbonyl compounds, some of which possess the papery or cardboard or leathery flavor and aroma characteristic of stale beer. Acetaldehyde is also a prominent early staling compound. Some of these so-called staling compounds have very low flavor/aroma thresholds. Trans-2-nonenal has a threshold of less than 1 part per billion, and is thought by the majority of researchers to be chiefly responsible for the papery/cardboard aroma and flavor that is generated in the early stages of beer aging. The hydroperoxide compounds formed as initial oxidation products can also serve as initiators of detrimental reactions that occur later in the brewing process. Other aldehydes, such as phenylacetaldeyde and 3-methylbutanal are known indicators of thermal abuse in beer.

The process by which fermentable sugars are extracted from the malt is called mashing. The liquid produced in the mashing step is called the mash. Lipoxygenase enzymes are still active during portions of the mashing step and can rapidly generate lipid hydroperoxides that can serve as oxidation initiators in later steps. Exposure to oxygen at this or nearly any other step in the brewing process can have detrimental effects on ultimate beer flavor stability.

The fermentable liquid produced in mashing is separated from the spent grains by some form of filtering. During this filtering operation, which takes place at elevated temperature with full exposure to air, the mash is exposed to oxygen and oxidation can occur.

The fermentable liquid, together with any added adjuncts is combined with hops or hop extracts and boiled to form wort. Oxidation can occur in this thermal process. After the wort is cooled, the yeast is pitched and the mixture is oxygenated by bubbling air through it. This step is another obvious place where oxidation can occur.

After the air addition, the yeast metabolizes the oxygen and the ferment goes anaerobic. Almost all of the aldehydes and ketones produced in the previous oxidative steps are reduced to alcohols by the yeast. Some researchers believe that sulfite produced by the yeast forms 1,2-adducts with aldehydes and prevent their reduction. These protected bisulfite adducts pass into the finished beer where the addition reaction is reversed, freeing up the aldehydes and resulting in production of off-flavor compounds. Other researchers believe that aldehydes formed early in the brewing process form Schiff base compounds with proteins and that these compounds disassociate in the packaged beer to regenerate staling aldehydes. In this case, oxidation that occurs early in the brewing process is made manifest much later in the process.

Packaging is another key part of the process where oxidation can readily occur. It is very important to limit the amount of oxygen that gets into the bottle or can during this step. Over the last several decades, brewers have been able to dramatically lower the amount of oxygen introduced into beer during packaging. This improvement has translated into better product shelf life, generally, but further reductions in the levels of oxygen will come at much greater cost and provide proportionally less improvement in flavor stability. Bamforth [2000] states that even at 0.1 ppb oxygen (a ridiculously low level) there is ample scope for oxidative damage. Other authors point out that oxygen present in finished beer in combined form, such as hydroperoxides, for example, is sufficient to cause the detrimental flavor changes that occur on further aging.

Unwanted flavor changes occur during pasteurization and some of these reactions are undoubtedly due to oxidation processes. In the pasteurization process, brewers trade off the loss of some amount of fresh brewed flavor for an enhanced microbial stability.

The complexity of the problem of beer flavor stability is highlighted by the current level of disagreement in both the industry and research communities as to the causes and solutions. Many questions are actively debated. The relative importance of various proposed pathways for stale flavor development remains unclear and the nature of the precursors for the staling compounds has not been unequivocally established [De Cooman, et al., 2000]. Some of the varied attempts to solve the problem of beer flavor instability are described below.

A sense of the debate can be gotten from the many reviews of the chemistry of beer flavor stability in the literature (and references cited therein), including:
M. Dadic, “Beer Stability—A Key to Success in Brewing,” Tech. Q. Master Brew. Assoc. Am., 21(1): 9-26,1984.
M. T. Walters, “Natural Antioxidants and Flavour Stability,” Ferment, 10(2), 111-119, 1997.
W. Back, C. Forster, M. Kratienthaler, J. Lehmann, B. Sacher and B. Thum, “New Research Findings on Improving Taste Stability,” Brauwelt Int., 394-405, 1999.
C. W. Bamforth, “Making Sense of Flavor Change in Beer,” Proc. Cong.—Eur. Brew. Conv., 37(2), 165-171, 2000.
   Exogenous Antioxidants

Many substances have been evaluated to preserve the fresh flavor of beer. Among these are ascorbic acid, EDTA, catechins, polyphenols and ascorbates. Some of these may have a deleterious effect on beer flavor stability. For example, it has been suggested that ascorbic acid can act as a pro-oxidant for polyphenols present in beer.

Walter et al. [1997, parts one and two] screened a number of imputed natural antioxidants in standardized antioxidant assays. Among them were catechin, quercitin, and green tea extract, which are or contain polyphenols, and found them to be ineffective. They also tried ferulic acid, caffeic acid and sinapic acid. Among other things, they tried herbal extracts of ginger, oregano (a member of the Labiatae family), a “spice cocktail”, and a trademarked substance called Herbor H41. The herbal extracts, including oregano and Herbor 41 were not chosen for further study because they were not sufficiently effective to warrant further investigation. Ferulic acid and catechin were chosen for further study which involved a beer staling assay. Therefore, the prior art, such as it is, shows that Labiatae extracts, and more particularly, those containing CA, CN and RA, are not effective in preventing staling, and no one has tested a Labiatae herb extract in a beer preparation for staling.

Dadic [1984] concluded that widely used food antioxidants, BHA and BHT were ineffective.

To date, no truly effective or commercially viable solution to the complex problem of beer flavor instability has been implemented by the brewing industry.

The home brewing community shares recipes on the internet. There are several recipes that feature the addition of spices into the brewing process for the purpose of obtaining a distinctive flavor. At the http://byo.com/feature/56.html website, adding thyme, basil, peppermint and rosemary to home brews is discussed. Directions are given for adding an ethanol extract or solution of the spice made using vodka or a tea made from hot water in the case of peppermint. These spices are not added to improve flavor stability. They are added simply as a flavoring and at quantities well above the flavor threshold to impart a flavor to the product. Other examples are listed at http://byo.com/recipe/298.html and http://www.cs.csustan.edu/˜gcrawfor/beerfiles/holiday.html. In contrast, our invention is a flavor stabilizing method that does not impart flavor changes to the beverage.

Flavored malt beverages, because of the use of distilled spirits as well as a purified fermented water base, are less prone to develop the kinds of staling flavors associated with beer. Nevertheless, due to the residuals from the fermentation, instability of the added flavors and staling can occur. This flavor instability and staling can be reduced by mixtures of CA, CN and RA more effectively than with RA alone. It is known that RA is particularly effective in preventing the degradation of citral and because it is water soluble, it has been added to carbonated citrus drinks. However, we find the combination of RA and CA of the present invention to be surprisingly more effective in preventing flavor degradation in citrus flavored beverages and in flavored malt beverages. It should be noted that flavored malt beverages are very different in constituents than beers and malt beverages, since they depend upon the addition of distilled spirits and therefor have a very much-reduced redox potential. The beer aromatics and hop flavors are stripped away and greatly reduced. Effective doses in beers do not necessarily correlate with effective doses in flavored malt beverages, and there are none of the melanoidins or similar compounds present in effective amounts.

In spite of the efforts to understand the factors affecting beer flavor stability and to produce beers with acceptable flavor stability, the problem remains a quality issue with significant economic implications. The importance of the problem is indicated by the fact that flavor stability research is the largest area of research in brewing today [N. J. Huige, 1993].

The use of Labiatae herb extracts has not been demonstrated or suggested to solve this problem.

Non-Malt Beverages

Two patents have been issued that use rosemary extracts to prevent disappearance of citral or degradation of limonene and the like in citrus-flavored and other beverages. Todd (U.S. Pat. No. 5,023,017) and Bank et al. (U.S. Pat. No. 6,306,450). These beverages are non-alcoholic and not subject to the development of cardboard and other staling flavors present in beer, for they are not fermented products from malt. They do not suggest, nor may it be assumed from these references, that CA, CN and RA will delay beer staling. These beverages do suffer flavor loss and off-flavor development based on degradation reactions of the added flavors.

What is clear from these teachings and the findings in this application is that it is impossible to predict the effect of an antioxidant additive on the flavor stability of beer. The use of Labiatae herb extracts to help preserve fresh flavor in beer has not been previously disclosed or suggested.

Labiatae herb extracts have preservative effects on other beverage systems whose flavor and aroma are the result of complex mixtures of flavor and aroma chemicals. A good example of a complex flavor and aroma system would be coffee flavor extracts.

The performance of oil soluble or lipophilic Labiatae herb extracts or constituents is especially surprising in aqueous based beverage systems such as beer, citrus, fruit, berry and cola flavored still soft drinks and carbonated beverages and coffee.

### OBJECTS OF THE INVENTION

It is an object of this invention to provide a method for increasing the flavor shelf life of malt beverages and beer by treating finished beer with carnosic acid, carnosol or mixtures thereof.

It is a further object of this invention to provide a method for increasing the flavor shelf life of malt beverages and beer by adding an ingredient comprising rosmarinic acid, carnosic acid and carnosol into various stages in the brewing process.

It is a further object of this invention to provide a method for improving the flavor stability of malt beverages and beer by adding an ingredient comprising rosmarinic acid in any or all of the brewing process steps prior to wort boil and by adding an ingredient comprising carnosic acid and/or carnosol to any or all of the brewing process steps during or after wort boil.

It is a further object of this invention to enhance the redox potential of mash used in brewing by adding an ingredient comprising rosmarinic acid prior to or during the formation of mash from malted grains.

It is a further object of this invention to enhance the redox potential of finished beer by adding an ingredient comprising carnosic acid to beer, post-fermentation.

It is a further object of the present invention to minimize the loss of redox potential of malt beverages and beer during the pasteurization process by adding an ingredient comprising carnosic acid and/or carnosol to any step in the brewing process from and including wort boil to immediately prior to the pasteurization step.

It is a further object of this invention to reduce the rate of change in the ratio of cis to trans isohumulones or reduced isohumulones upon storage of the beer, by the addition of an ingredient comprising carnosic acid or a mixture of carnosic acid and rosmarinic acid to the finished beer or to any stage in the manufacture of the beer.

It is further an object of this invention to preserve the color of a beer during storage by the addition of an ingredient comprising carnosic acid or a mixture of carnosic acid and rosmarinic acid to the finished beer or to any stage in the manufacture of the beer.

It is a further object of this invention to provide a method for preserving the redox potential of finished beer that has been exposed to injurious levels of oxygen by adding an ingredient comprising carnosic acid, rosmarinic acid or mixtures thereof to a step in the manufacturing process.

It is a further object of this invention to provide a method for delaying haze formation in aged beers, especially those exposed to injurious levels of oxygen, by the addition of an ingredient comprising carnosic acid or rosmarinic acid and especially mixtures thereof.

It is a further object of this invention to provide a method for delaying the formation of phenylacetaldehyde and 3-methylbutanal in aged or thermally abused beer by addition of an ingredient comprising carnosic acid or rosmarinic acid and especially mixtures thereof.

It is a further object of this invention to provide a method for enhancing the flavor shelf life of flavored coffees, citrus, fruit, berry and cola flavored still soft drinks and carbonated beverages by the addition of an ingredient comprising carnosic acid and mixtures of carnosic acid, carnosol and rosmarinic acid.

Definitions

Redox potential in this application is the value obtained by the DCIP test as measured by the method described in Methodensammlung der Mitteleuropäischen Brautechnischene Analösen Kommission, Vierte Ausgabe 2002, Editor Prof. Dr. H. Miedaner, Weihenstephan, p.104-107.

Finished beer in this application is defined as beer that has gone through the entire brewing process and is ready to be consumed, whether just prior to packaging or packaged in kegs, barrels, bottles or cans or other containers.

Inventive compositions in this application refer to a Labiatae herb extract or Labiatae herb constituents comprising carnosic acid; carnosol; rosmarinic acid; flavonoids, such as luteolin 7-glucuronide, luteolin 3′-glucuronide, luteolin 7-diglucuronide, and luteolin 7-glucuronide-3′-ferulyglucoside; rosmariquinone; rosmanol; epi-rosmanol; isorosmanol; rosmaridiphenol; 12-methoxycarnosic acid; and esters of carnosic acid, such as methyl carnosate and ethyl carnosate; and, optionally isohumulones; dihydro-isohumulones; tetrahydro-isohumulones; hexahydroisohumulones and hop oil. Oil soluble compositions may be combined with food grade additives, emulsifiers or diluents to enhance dispersibility in water. Acceptable food-grade carriers are ethanol, propylene glycol, benzyl alcohol or glycerin, monoglycerides of fatty acids, diglycerides of fatty acids, or sucrose esters and mixtures thereof. Water soluble compositions can likewise be combined with food grade additives like ethanol, propylene glycol, benzyl alcohol or glycerin, or mixtures thereof, to facilitate handling and ease of use.

### SUMMARY OF THE INVENTION

What we therefore believe to be comprised by our invention may be summarized inter alia in the following words:

Stabilizing Beer

We have found that the flavor stability of malt beverages, including beer, can be dramatically improved by adding Labiatae herb extracts or compounds derived from Labiatae herbs to one or more of the steps in the brewing process or to the finished beverage prior to packaging. The enhanced flavor stability has been measured in a variety of beers using panels conducted by trained flavor panelists. The increase in stability can also be inferred from the increase in the redox potential of treated beers vs. untreated beers.

Labiatae herb extracts or their effective components, primarily carnosic acid (CA), carnosol (CN), rosmarinic acid (RA) or flavonoids, such as luteolin 7-glucuronide; luteolin 3′-glucuronide; luteolin 7-diglucuronide and luteolin 7-glucuronide-3′-ferulyglucoside can be added into the brewing process during malting, mashing, fermentation or post-fermentation or combinations thereof. Only RA and flavonoids, such as luteolin 7-glucuronide; luteolin 3′-glucuronide; luteolin 7-diglucuronide and luteolin 7-glucuronide-3′-ferulyglucoside are considered water soluble. CN and CA are oil soluble, but can be made dispersible in water. At low concentrations, less than 100 ppm, carnosic acid and carnosol are soluble in beer and malt beverages. In addition to these phenolic type compounds, others may be present in minor amounts in the herb extract, and these have a positive effect on beer stability. These compounds include: rosmariquinone, rosmanol, epi-rosmanol, isorosmanol, rosmaridiphenol, 12-methoxycarnosic acid, and esters of carnosic acid, such as methyl carnosate and ethyl carnosate.

Carnosic Acid, carnosol, rosmarinic acid, flavonoids, such as luteolin 7-glucuronide; luteolin 3′-glucuronide; luteolin 7-diglucuronide and luteolin 7-glucuronide-3′-ferulyglucoside and related compounds are present in some Labiatae herbs and in various extracts of Labiatae herbs. Labiatae herbs containing carnosic acid and/or carnosol include rosemary (Rosmarinus officinalis), sage (Salvia officinalis) and others. Labiatae herbs containing rosmarinic acid and/or flavonoids, such as luteolin 7-glucuronide; luteolin 3′-glucuronide; luteolin 7-diglucuronide and luteolin 7-glucuronide-3′-ferulyglucoside include rosemary (Rosmarinus officinalis), sage (Salvia officinalis), marjoram (Majorana hortensis), thyme (Thymus vulgaris), spearmint (Mentha spicata), peppermint (Mentha piperita), basil (Ocimum basilicum), summer savory (Satureja hortensis), oregano (Origanum vulgare) and others. In many cases, Labiatae herb extracts, rather than the more difficult to obtain purified constituents can be employed to attain the desired stabilizing effects. In other cases, it may be necessary to refine the crude extracts to both increase the concentration of the stabilizing constituents, and to remove those ingredients that are high in flavor or are incompatible in some way with the finished beverage product. Oleoresin extracts containing from 2-25% active ingredients (carnosic acid, carnosol and rosmarinic acid plus flavonoids) can be employed to attain the stabilizing effects when added to certain points in the brewing process. Partially refined carnosol or carnosic acid, containing between 25 to 70% active ingredient are useful forms adaptable to the present invention. Highly purified carnosic acid, carnosol and rosmarinic acid (>70% purity) can also be effectively employed in the present invention. Mixtures of carnosol, carnosic acid rosmarinic acid, flavonoids, such as luteolin 7-glucuronide; luteolin 3′-glucuronide; luteolin 7-diglucuronide or luteolin 7-glucuronide-3′-ferulyglucoside and the other compounds disclosed above are also effective in the present invention, sometimes showing unusual stabilizing effects.

The effect of the constituent Labiatae herb antioxidants is not straightforward. While rosmarinic acid is not a very effective compound for enhancing the redox potential of beer when added to the finished product, we have found it to be very effective in enhancing the redox potential of finished beer and intermediates stages of the brewing process when added early in the brewing process. Rosmarinic acid is particularly effective at enhancing the redox potential of mash. Rosmarinic acid preserves fresh flavor in beer when added early in the brewing process. Rosmarinic acid sometimes preserves fresh flavor when added to the finished product, but sometimes does not. We do not understand the reasons for this variable behavior, but suspect it might be due to small differences in the ingredients, thermal history, and aging history of the beers we have examined. Rosmarinic acid enhances the redox potential of mash, when added to the mashing process, as measured by the DCIP method. An equivalent amount of carnosic acid added to the mashing process has an enhancing effect on the redox potential, but not as large a one as the addition of rosmarinic acid. Carnosol, which shows little effect on redox potential, as measured by the DCIP method, none-the-less preserves fresh beer flavor. Carnosic acid enhances and preserves the redox potential in beer (DCIP method) and preserves fresh beer flavor when added late in the brewing process or to finished beer, but has less effect on redox potential when added early in the brewing process.

A composition combining a Labiatae herb extract, or chemical compounds derived from Labiatae herb extracts with hop bitter acids, including either isohumulone, dihydroisohumulone, tetrahydroisohumulone or hexahydroisohumulone, or mixtures thereof, and optionally hop oils, can be added to a beer in a post-fermentation step, in a particularly convenient and cost effective way of preparing a beer with enhanced flavor stability.

Stabilizing Non-Malt Beverages

We have also found that treating certain non-malt beverages with extracts or constituents of Labiatae herbs can extend their flavor shelf lives. We include in this invention, the stabilization of citrus, fruit, berry and cola flavored still soft drinks and carbonated beverages using the oil soluble antioxidant constituents of Labiatae herbs, such as carnosic acid and carnosol, and especially, combinations of oil soluble and water soluble constituents of Labiatae herbs as opposed to only rosmarinic acid and flavonoids, such as luteolin 7-glucuronide; luteolin 3′-glucuronide; luteolin 7-diglucuronide and luteolin 7-glucuronide-3′-ferulyglucoside. Flavor stabilizing compositions as described below can be added to the finished beverage or at some stage in its manufacture.

Such a method for enhancing the stability of a beverage, comprising addition of Labiatae herb extracts or constituents of Labiatae herbs, optionally formulated in a food grade carrier, to the beverage or to some point in its manufacture.

Such a method, wherein the beverage is selected from malt beverages, beer, ale, dry beer, near beer, light beer, low alcohol beer, low calorie beer, porter, bock beer, stout, malt liquor, non-alcoholic malt beverages, and beer in which the alcohol has been removed.

Such a method, wherein the beverage is selected from coffee, flavored coffees, fortified soft drinks, energy drinks, citrus drinks, fruit drinks, berry and cola flavored still soft drinks and carbonated beverages, fruit juices, and flavored malt beverages.

Such a method, wherein the Labiatae herb extract comprises a crude Labiatae herb extract, carnosic acid and mixtures of carnosic acid, carnosol, and rosmarinic acid.

Such a method for enhancing flavor stability of malt beverages and beer comprising addition of a Labiatae herb extract to the beer or malt beverage.

Such a method, wherein the Labiatae herb extract comprises a crude Labiatae herb extract, carnosic acid and mixtures of carnosic acid, carnosol, and rosmarinic acid.

Such a method for enhancing flavor stability of malt beverages and beer comprising addition of a Labiatae herb extract during beer manufacture.

Such a method, wherein the Labiatae herb extract comprises a crude Labiatae herb extract, carnosic acid and mixtures of carnosic acid, carnosol, and rosmarinic acid.

Such a method, wherein the Labiatae herb extract is added at one or more stages of malt beverage or beer manufacture selected from
to cereal grains prior to the malting process,
to cereal grains during the malting process,
prior to the mashing process,
during the mashing process,
prior to the lautering process,
during the lautering process,
prior to the wort boil,
during the wort boil,
just prior to the fermenting process,
during the fermenting process, and
after fermentation.

Such a method for enhancing flavor stability of malt beverages and beer comprising addition of rosmarinic acid in any or all of the stages of beverage manufacture prior to wort boil and/or addition of carnosic acid and/or carnosol to any or all of the stages of beverage manufacture during or after wort boil.

Such a method for enhancing flavor stability of malt beverages and beer comprising addition of rosmarinic acid in any or all of the beverage manufacture steps prior to wort boil.

Such a method for enhancing the flavor stability of malt beverages and beer comprising addition of carnosic acid and/or carnosol to any or all of the stages of beverage manufacture during or after wort boil.

Such a method for enhancing redox potential of malt beverages or beer comprising addition of Labiatae herb extracts to any or all of the stages of manufacture.

Such a method for enhancing redox potential of malt beverages or beer comprising addition of rosmarinic acid to any or all of the stages of manufacture.

Such a method for enhancing redox potential of mash comprising addition of Labiatae herb extracts prior to the mashing process, malting process, kilning process, or a combination thereof.

Such a method for enhancing redox potential of mash comprising addition of rosmarinic acid prior to the formation of mash from malted grains.

Such a method for enhancing the redox potential of mash comprising addition of rosmarinic acid during the formation of mash from malted grains.

Such a method for enhancing redox potential of malt beverages or beer comprising addition of carnosic acid to any or all of the stages of manufacture.

Such a method for enhancing redox potential of malt beverages or beer comprising addition of carnosic acid to the beverage after fermentation.

Such a method for minimizing the loss of redox potential of malt beverages and beer during the pasteurization process comprising addition of carnosic acid and/or carnosol to any stage of manufacture from and including wort boil to immediately prior to the pasteurization step.

Such a method for preserving hop bitter acids in malt beverages and beer upon storage, comprising addition of carnosic acid or a mixture of carnosic acid and rosmarinic acid to finished malt beverage or beer or to any stage in the manufacture of the malt beverage or beer.

Such a method wherein the rate of change in the ratio of cis to trans isohumulones or reduced isohumulones is reduced.

Such a method for preserving malt beverage or beer color during storage, comprising addition of carnosic acid or a mixture of carnosic acid and rosmarinic acid to the beverage or to any stage in the manufacture of the beverage.

Such a method for preserving the redox potential of a malt beverage or beer which has been exposed to injurious levels of oxygen comprising addition of carnosic acid, rosmarinic acid, and/or mixtures thereof to a step in the manufacture of the beverage.

Such a method for delaying haze formation in aged malt beverages or beers comprising addition of carnosic acid, rosmarinic acid, and/or mixtures thereof to the beverage.

Such a method, wherein the aged malt beverage or beer has been exposed to injurious levels of oxygen.

Such a method for delaying the formation of hop and/or malt degradation products in aged or thermally abused malt beverage or beer comprising addition of carnosic acid, rosmarinic acid, and/or mixtures thereof to the malt beverage or beer either before during or after manufacture.

Such a method wherein the hop and/or malt degradation products are selected from volatile carbonyl compounds, trans-2-nonenal, phenylacetaldehyde and 3-methylbutanal.

Such a method for protecting the natural melanoidins, polyphenols, and sulfites in a malt beverage or beer comprising addition of a Labiatae herb extract before or during manufacture or both before and during manufacture.

Such a method for protecting against oxidative phenomena comprising addition of a Labiatae herb extract before or during malt beverage or beer manufacture or both before and during manufacture.

Such a method for protecting against lipid hydroperoxides during the mashing step of malt beverage or beer manufacture comprising addition of a Labiatae herb extract before or during manufacture or both before and during manufacture.

Such a method, wherein the Labiatae herb extract is provided below the flavor threshold.

Such a method, wherein the Labiatae herb extract is formulated in a food grade carrier comprising propylene glycol, ethanol, water, monoglycerides of fatty acids, diglycerides of fatty acids or glycerin, or mixtures thereof.

### DETAILED DESCRIPTION OF THE INVENTION

Malt Beverages and Beer

The present invention involves the use of Labiatae herb extracts or compounds derived from Labiatae herbs to help preserve the fresh flavor of malt beverages, including beer. The form of the Labiatae herb extracts or compounds derived from Labiatae herbs can vary considerably in terms of properties and purity. Many of the active antioxidant ingredients in the Labiatae herbs are phenolic compounds, such as carnosic acid, carnosol, rosmarinic acid, and flavonoids and their derivatives. The invention can be practiced on a variety of steps in the brewing process or on a combination of these process steps.

We have found that extracts of Labiatae herbs or compounds consisting essentially of carnosic acid, carnosol, rosmarinic acid and their derivatives, derived from these extracts in varying degrees of purity can be used in various stages of the brewing process to improve the flavor stability of the resulting malt beverage. The extracts or compounds can be added in a single step, or in any combination of the steps outlined below. Both water-soluble (hydrophylic) and oil-soluble (lipophilic) extracts can be used. One or the other of these kinds of extracts may work better in a given process step. Oil soluble extracts, or their partially or highly refined constituents, carnosic acid and carnosol may be combined with food grade additives, emulsifiers or diluents to enhance dispersibility in water. Acceptable food-grade carriers are ethanol, propylene glycol, benzyl alcohol or glycerin, monoglycerides of fatty acids, diglycerides of fatty acids, or sucrose esters and mixtures thereof. The water soluble components of the Labiatae herb extracts can likewise be combined with food grade additives like ethanol, propylene glycol, benzyl alcohol or glycerin, or mixtures thereof, to facilitate handling and ease of use.

In latter stages of the brewing process, compositions containing both hop bittering acids and Labiatae herb extracts or compounds isolated from Labiatae herbs form a particularly convenient composition for providing bitterness and flavor stability to a malted beverage. These compositions are described in more detail in Example 10.

During Malting

Extracts of Labiatae herbs or Labiatae herbs compounds consisting essentially of carnosic acid, carnosol, rosmarinic acid, Labiatae herb-derived flavonoids and their derivatives, can be added before or during the grain-malting step. A convenient method of adding the extract or compound is to incorporate the extract or compounds into the water used to increase the grain moisture and initiate germination. Even a crude extract containing waxes may be suitable for use in this process. The oil soluble components are best formulated into a water dispersible form by compounding them with a water soluble carrier, such as ethanol, propylene glycol, glycerin, or partially water soluble carrier such as benzyl alcohol, monoglycerides of fatty acids, diglycerides of fatty acids, sucrose esters or mixtures thereof. The extracts can be added in the amount of between 5 and 5000 parts per million based upon weight of the grain. This range reflects the different concentrations of active ingredients that can occur in the extract. Obviously, the higher the concentration of active ingredients used, the smaller the extract dose will need to be. This is true for this process step and for all the others as well.

Compounds such as carnosic acid, carnosol, rosmarinic acid or Labiatae herb-derived flavonoids in a more purified form can be added at levels resulting in final concentrations of between about 2 and 250 ppm of pure compound, based upon grain weight. Both oil soluble and water soluble extracts can be effectively used in this step of the brewing process to produce a beneficial effect, although rosmarinic acid provides the greatest benefit. Surprisingly, rosmarinic acid added early in the brewing process, such as at this stage, increases the redox potential of the beer, as measured by the DCIP method, even though adding rosmarinic acid to a finished beer does not increase the redox potential of the beer and even though rosmarinic acid is not reactive with DCIP. The oil soluble Labiatae herb constituents provide some benefit when added to this step in the process but are more effective when added later in the process.

During Kilning and Grinding

Labiatae herb extracts or compounds derived from Labiatae herbs can be added to the grain prior to kilning to protect the lipids. Barley is approximately 2.5% lipids are there is no practical way to exclude air from this process. The inventive compositions can be sprayed onto the grain prior to kilning. A crude extract containing waxes may be suitable for use in this process, but more highly refined Labiatae herb constituents can also be used effectively. The oil soluble components are best formulated into a water dispersible form by compounding them with a water soluble carrier, such as ethanol, propylene glycol, glycerin or a partially water soluble carrier such as benzyl alcohol, monoglycerides of fatty acids, diglycerides of fatty acids, or sucrose esters or mixtures thereof. After kilning, the grain is ground using either wet or dry processes. The freshly kilned grain can be treated with the inventive compositions prior to or during the grinding process. The amounts of inventive composition to be added are the same as described in the malting section.

During Mashing

Labiatae herb extracts or compounds comprising carnosic acid, carnosol, rosmarinic acid, flavonoids and their derivatives, derived from Labiatae herbs can be added during the mashing step. A convenient method of adding the extract or compound is to incorporate the extract or compounds into the water used to extract the fermentable sugars. The extracts can be added in the amount of between 5 and 5000 parts per million based upon weight of the malted grain. Compounds such as carnosic acid, carnosol or rosmarinic acid in a more purified form can be added at levels resulting in final concentrations of between 2 and 250 ppm based upon malted grain weight. Both oil soluble and water soluble extracts can be effectively used in this step of the brewing process. The oil soluble components are best formulated into a water dispersible form by compounding them with a water soluble carrier, such as ethanol, propylene glycol, glycerin, or a partially water soluble carrier such as benzyl alcohol, monoglycerides of fatty acids, diglycerides of fatty acids, or sucrose esters or mixtures thereof. Even a crude extract containing waxes may be suitable for use in this process. Both oil soluble and water soluble extracts can be effectively used in this step of the brewing process to produce a beneficial effect, although rosmarinic acid provides the greatest benefit. The oil soluble Labiatae herb constituents provide some benefit when added to this step in the process but are more effective when added later in the process.

After Filtering (Lautering)

Labiatae herb extracts or compounds consisting essentially of carnosic acid, carnosol, rosmarinic acid, flavonoids and their derivatives, derived from Labiatae herbs can be added to the mash after separation from the spent grains. The extracts can be added in the amount of between 5 and 5000 parts per million based upon weight of the fermentable liquid. Compounds such as carnosic acid, carnosol or rosmarinic acid in a more purified form can be added at levels resulting in final concentrations of between 5 and 250 ppm based upon weight of the fermentable liquid. Both oil soluble and water soluble extracts can be effectively used in this step of the brewing process. The oil soluble components are best formulated into a water dispersible form by compounding them with a water soluble carrier, such as ethanol, propylene glycol, glycerin, or a partially water soluble carrier such as benzyl alcohol, monoglycerides of fatty acids, diglycerides of fatty acids, sucrose esters or mixtures thereof.

During Wort Boil

Labiatae herb extracts or compounds consisting essentially of carnosic acid, carnosol, rosmarinic acid, flavonoids and their derivatives, derived from Labiatae herbs can be added to the wort prior to, during or after the wort boil. The extracts can be added in the amount of between 5 and 5000 parts per million based upon weight of the wort. Compounds such as carnosic acid, carnosol or rosmarinic acid in a more purified form can be added at levels resulting in final concentrations of between 2 and 250 ppm based upon weight of the wort. Both oil soluble and water soluble extracts can be effectively used in this step of the brewing process. Even a crude extract containing waxes may be suitable for use in this process.

During Fermentation

Labiatae herb extracts or compounds consisting essentially of carnosic acid, carnosol, rosmarinic acid and their derivatives, derived from Labiatae herbs can be added to the wort prior to or during fermentation. The extracts can be added in the amount of between 5 and 5000 parts per million based upon weight of the wort. Compounds such as carnosic acid, carnosol or rosmarinic acid in a more purified form can be added at levels resulting in final concentrations of between 2 and 250 ppm based upon weight of the wort. A more preferred range is from 10 to 200 ppm. Both oil soluble and water soluble extracts can be effectively used in this step of the brewing process, although extracts relatively low in triglycerides or free fatty acids are preferred. Carnosic acid or extracts containing carnosic acid are more effective than rosmarinic acid or extracts containing rosmarinic acid, added in equivalent amounts.

Post Fermentation

Labiatae herb extracts or compounds derived from Labiatae herbs can be added to the fermented malt beverage. The extracts can be added in the amount of between 1 and 2000 parts per million based upon weight of the malt beverage. Compounds such as carnosic acid, carnosol or rosmarinic acid in a more purified form can be added at levels resulting in final concentrations of between 1 and 100 ppm based upon malt beverage weight. Surprisingly, the more oil soluble constituents, carnosic acid and carnosol are the most effective additives at this step. Rosmarinic acid addition at this step is also beneficial to flavor stability. Surprisingly, the mixture of carnosic acid and rosmarinic acid is more effective than an equivalent amount of either of the ingredients alone. Solutions of pure compounds, carnosic acid, carnosol and rosmarinic acid may be added as solutions in ethanol, propylene glycol, glycerin or benzyl alcohol, or mixtures thereof, optionally containing water.

Compositions combining a Labiatae herb extract, or chemical compounds derived from Labiatae herb extracts with hop bitter acids, including either isohumulone, dihydro-isohumulone, tetrahydro-isohumulone or hexahydro-isohumulone, or mixtures thereof, and optionally hop oils, added to a beer in a post-fermentation step, is a particularly convenient and cost effective way of preparing a beer with appropriate flavor, desirable foam characteristics and enhanced flavor stability. If the purity of the extracts or compounds added is sufficiently high, the compositions can be added to beer forming a clear product that does not require filtration. If purity levels or addition levels are not sufficient to provide a clear product, a post-addition filtration step might be required. It is preferred to add the flavor-stabilizing package prior to filtration. The addition of Labiatae herb constituents at this stage of the brewing process is a particularly effective way of preserving flavor and redox potential during the pasteurization process.

Addition of Labiatae Herb Extracts and/or Labiatae Herb Constituents to Multiple Brewing Process Steps and the Importance of Order of Addition.

We have found that Labiatae herb extracts and/or Labiatae herb constituents can be added to more than one of the brewing process steps and that the order of addition of the treatments can have a significant effect on the flavor stabilizing result. In a set of two experiments run in a commercial pilot brewery, two brews were made with additions at both the sparge water and the kettle boil start points in the brewing process. In one of the brews, a rosmarinic acid preparation was added to the sparge water and a carnosic acid preparation was added to the start of kettle boil. In the other brew, the carnosic acid preparation was added to the sparge water and the rosmarinic acid preparation was added to the start of kettle boil. The example where the rosmarinic acid was added early in the process and the carnosic acid was added later proved to have the best flavor stability. The example where the order of addition was reversed actually scored worse than untreated controls in flavor evaluations of aged beer.

The effect of Labiatae Herb Extracts and Labiatae Herb Constituents on Hop Acid Stability.

Araki, et al. [2002] and L. De Cooman et al. [2001] have suggested that the ratio of cis to trans isomers of isohumulones is a chemical marker for beer aging. We have found that adding Labiatae herb extracts or Labiatae herb constituents to beer has a protective effect on this ratio. Carnosic acid was an effective protective agent, but the combination of carnosic acid and rosmarinic acid was even more effective.

The effect of Labiatae Herb Extracts and Labiatae Herb Constituents on the Formation of Thermal Abuse Markers.

Phenylacetaldehyde and 3-methylbutanal concentrations increase in beer as a result of thermal abuse. Treating the beer with the compositions of the present invention can slow down the rate of formation of these degradation products. Rosmarinic acid, carnosic acid and mixtures of the two were all very effective at slowing the formation, particularly in the presence of air.

We have found that Labiatae herb compounds show a beneficial effect in decreasing haze formation in aged beers exposed to oxygen. Carnosic acid and rosmarinic acid and combinations of carnosic acid and rosmarinic acid have a dramatic positive effect on reducing the rate of haze formation in aged beer that has been exposed to air. The treatments do not increase the amount of haze that is formed in aged beer that has been properly packaged and protected from air.

The examples, below, show the very marked effect of both crude and refined rosemary, sage, and other Labiatae extracts on inhibiting and retarding the development of staling flavors in beer. They show the effects of adding the inventive compositions to finished beer and to various stages in the brewing process. These examples show the unique and unpredictable differences in the behavior of rosmarinic acid and carnosic acid in preserving redox potential and in preserving fresh beer flavor. The examples show a beneficial effect of Labiatae herb extracts or Labiatae herb constituents on slowing the rate of color change that occurs in beer upon aging, and especially in aging beer exposed to oxygen. They describe the interesting phenomenon that rosmarinic acid is best added early in the brewing process and that carnosic acid is most effective when added late. These experiments were conducted in different types of beer: a very hoppy, bitter, and aromatic beer, a conventional Lager, a semi-light beer and a very light beer. All showed the positive effects of the extracts. The same effects will occur in other types of malt beverages, as described above.

Since there is great variation in commercial beers, it is to be expected that the effect of the extracts will be more pronounced in some beers than in others. If a beer has already begun to deteriorate, or is made with substandard raw materials, the extracts will have a lesser effect.

The Labiatae herb extracts and Labiatae herb constituents preferably have the great majority of the aromatic aromas and flavors removed, by a steam distillation, vacuum distillation or similar process so that there will be no change in the flavor of the beer as a result of the additive.

The aging was done at two temperatures, 39-40° C. and 32° C. These temperatures are encountered in distribution systems in the southern United States and in tropical countries.

As a rule of thumb, storage at 40° C. for 4 days is equivalent to 3-4 months storage at 20° C. [Back, et al. 1999], although this correlation is probably dependent upon the type of beer being studied. As was the case in Example 1, the aged control was stale in less than one week, while the dosed sample remained similar to the cold fresh beer. The treated beer would have had a shelf life of roughly greater than about 4 months. In Example 3, at 32° C., the undosed beer was stale after 6 days, but the dosed beers were still fresh after 6 days.

The elimination of staling in normal distribution channels will have a very significant economic impact on the brewer since it will lessen the return of their staled beverages.

It is important for the brewer to recognize that different types of beer will age at different rates. Thus, a very low dose of 1 or 2 ppm may be effective for a relatively stable beer, whereas a highly unstable beer may require 5 or more ppm to achieve the shelf life desired. The preferred dosing will vary from beer to beer, but is generally in the range of about 1 to 100 ppm, and preferably 5 to 25 ppm in a light beer. In some cases doses of 100 ppm or more will be found desirable. If properly prepared, the dosed extracts will not contribute flavor to the beer, even at the highest levels, for they are not aromatic as are conventional herb extracts or tinctures which contribute desired flavor and aroma effects at even 1 ppm. This full-flavored type of extract or tincture will contain substantially less RA, CA and CN than 1 ppm when diluted so that no herbal flavor is present, which is not enough to prevent staling.

Certain Labiatae herb extracts or compounds derived from Labiatae herbs provide surprisingly beneficial effects on preserving the fresh flavor of beer when added post-fermentation. The effects are readily apparent from a consideration of the following examples.

The Labiatae herbs may include rosemary, sage, spearmint, peppermint, basil, oregano and all other members of the Labiatae group. The following Examples are given to illustrate the present invention, but are not to be construed as limiting.

Non-Malt Beverages

Although the chemistry associated with flavor instability in non-malt beverages, such as flavored coffees, citrus, fruit cola and berry-flavored soft drinks and carbonated beverages, is certainly different than the chemistry associated with flavor instability in beer, we have found that Labiatae herb extracts and Labiatae herb constituents are, none-the-less, useful additives capable of extending flavor shelf life in these beverages. In trials involving a model citrus-flavored beverage, it was shown that contrary to existing prior art, rosmarinic acid was not an effect flavor stabilizer. In a scaling study of staling in the model beverage, a combination of rosmarinic acid and carnosic acid was found to be the most effective flavor-stabilizing treatment.

The flavor-stabilizing compositions can be added to non-malt beverages most conveniently by combining them with the flavoring formulations used in their manufacture. Of course, the flavor-stabilizing ingredients can be added separately at various steps in the beverage manufacturing process, including into the finished beverage just prior to packaging.

Experimental Part

The present invention will be better understood in connection with the following examples, which are intended as an illustration of and not a limitation upon the scope of the invention.

Materials and Methods Generally

Labiatae herb extracts, both oil and water soluble varieties, were prepared from the ground whole herb by extraction using techniques well known in the art. Extracts reduced in flavor intensity are preferable, prepared using methods well known in the art to remove a portion of the volatile flavor constituents of these extracts either prior to or after extraction.

Carnosic acid (CA) was isolated from rosemary and from sage extract and was purified by recrystallization. Its purity was confirmed by reverse phase HPLC analysis.

Carnosol (CN) was isolated from rosemary and from sage extract and was purified by recrystallization. Its purity was confirmed by reverse phase HPLC.

Rosmarinic acid (RA) was isolated from rosemary, sage or spearmint and was purified by recrystallization. Its purity was confirmed by reverse phase HPLC.

The effect of Labiatae herb extracts has also been measured chemically, by measuring the effect of the Labiatae herb extracts on enhancing or preserving the native reducing capacity or redox potential of beer, by measuring the effect on hop acid cis/trans ratios and by measuring the effect on the formation of aldehydes that are beer staling markers.

### EXAMPLE 1

### Effect of Selected Labiatae Herb Extracts and Constituents on Flavor of a Commercial Pilsener Under Forced Aging Conditions

Separate solutions containing 2% pure rosmarinic acid or pure carnosic acid were prepared by weighing out 500 mg of each compound into separate volumetric flasks and diluting to 25 mL with 100% EtOH.

The beer used in this study was purchased at a local market with a production date of 36 days prior to use. Bottle additions were done as follows:
1. A bottle of the beer was opened, struck sharply on the top to induce foaming (called “fobbing”), and crowned. The fobbing excludes air. The bottle was swirled and inverted. This sample was designated “No Additions.”
2. Bottles of beer were opened and an aliquot of either the rosmarinic acid or carnosic acid solutions or a combination of each was added in an amount to give the correct addition rate. The bottle was then fobbed, as above and crowned. It was then swirled and inverted. The samples were designated appropriately to reflect the additive and concentration.

The following samples were prepared:

| | |
|---|---|
| A. | Water soluble rosemary extract − 25 ppm RA |
| B. | 20 ppm CA (purified) |
| C. | 20 ppm CA (purified) + 20 ppm RA (purified) |
| D. | 5 ppm CA (purified) |
| E. | 10 ppm CA purified |
| F. | Water soluble rosemary extract − 5 ppm RA |
| G. | No Additions |
| H. | Fresh Control |

The bottles were placed in a heated room at 40±1° C. in the dark for varying amounts of time. After the allotted aging time, the bottles of beer were transferred to a dark refrigerator and stored at approximately 2° to 4° C. until they were analyzed. Additional bottles from the same code were kept unopened in 2° to 4° C. storage. These unopened samples from the same beer code were labeled “Fresh Control” used to provide fresh samples for the trained panel.

At the appropriate times, a trained 7- or 8-member panel evaluated the beers. In the first study panels, the fresh sample was not identified. Members rated beers for nine attributes that are characteristic for beer: Malt, Yeast, Estery, Hops, Sweet, Stale/Oxidized, Sour/Acid, Solvent (Chemical), and Bitterness. The panel never evaluated more than four beers at a session. The ratings are shown below. The rankings are shown in Table 1. In some instances the results are displayed as the normalized sum of preference of all 8 panelists with 1 being most preferred, and 4 the least preferred.

TABLE 1
Enhancing Shelflife in a Commercial Pilsner Beer.

| | Storage | | |
|---|---|---|---|
| Sample | Condition | Results | |
| A. 25 ppm Water | 1 week 40° C. | 6 of 7 panelists preferred sample A to Fresh | |
| soluble rosemary | | Control or No Addition. No Addition sample | |
| extract | | described as papery, astringent and sour. | |
| A. 25 ppm Water | 1 week 40° C. | 8 of 8 panelists preferred sample A to No | |
| soluble rosemary | | Addition sample, and comparable to Fresh | |
| extract (repeat) | | Control. | |
| B. 20 ppm CA | 1 week 40° C. | Fresh Ranking | 2.2 |
| | | Sample B. ranking | 2.3 |
| | | No Additions Ranking | 3.4 |
| B. 20 ppm CA | 2 weeks 40° C. | Fresh Ranking | 1.8 |
| | | Sample B. ranking | 2.1 |
| | | No Additions Ranking | 3.1 |
| C. 20 ppm CA + 20 ppm | 1 week 40° C. | Fresh Ranking | 2.2 |
| RA | | Sample C. ranking | 2.1 |
| | | No Additions Ranking | 3.4 |
| C. 20 ppm CA + 20 ppm | 2 weeks 40° C. | Fresh Ranking | 1.8 |
| RA | | Sample C. ranking | 1.8 |
| | | No Additions Ranking | 3.1 |
| D. 5 ppm CA | 1 week 40° C. | Fresh Ranking | 2.0 |
| | | Sample D. ranking | 2.6 |
| | | No Additions Ranking | 3.0 |
| E. 10 ppm CA | 1 week 40° C. | Fresh Ranking | 2.0 |
| | | Sample E. ranking | 2.4 |
| | | No Additions Ranking | 3.0 |
| F. 5 ppm Water soluble | 1 week 40° C. | Fresh Ranking | 1.6 |
| rosemary extract | | Sample F. ranking | 2.1 |
| | | No Additions Ranking | 3.0 |

In every case, the flavor panelists showed a strong preference for the aged beer samples that had been treated with Labiatae herb extracts, over aged samples that had received no treatment. Treatment with Labiatae herb extracts or compounds derived from Labiatae herbs helped to preserve the fresh flavor of the beer.

### EXAMPLE 2

### Effect of Selected Labiatae Herb Extracts and Constituents on Flavor of a Highly Hopped, Aromatic Commercial Beer Under Forced Aging Conditions

Separate solutions containing 2% pure rosmarinic acid or pure carnosic acid were prepared by weighing out 500 mg of each compound into separate volumetric flasks and diluting to 25 mL with 100% EtOH.

The beer used in this study was the freshest material available, being coded Nov 03 162C. It was purchased at a local market. Bottle additions were done as in Example 1. The following samples were prepared:

| | |
|---|---|
| I. | 20 ppm CA (purified) |
| J. | 20 ppm RA (purified) |
| K. | No Additions |
| L. | Fresh Control |

The bottles were placed in a heated room at 40±1° C. in the dark for varying amounts of time. After the allotted aging time, the bottles of beer were transferred to a dark refrigerator and stored at approximately 2to 4° C. until they were analyzed (always within 48 hours). Additional bottles from the same code were kept unopened in 2° to 4° C. storage. These unopened samples from the same beer code were labeled “Fresh Control” used to provide fresh samples for the trained panel.

At the appropriate times, a trained 8-member panel evaluated the beers. In this study panel, the identity of the fresh sample was revealed to the panelists who used it to calibrate versus the aged beer. Three beers were evaluated at each session—Fresh Control, Aged No Addition, and Aged Beer with one of the Labiatae treatments. The overall preference rank, the character and intensity of the aroma, the levels of paper/cardboard aroma and flavor, sour or off flavors, hang and astringency and bitterness quality and intensity were evaluated. The results are shown in Table 2.

TABLE 2
Enhancing Shelflife in a Highly Hopped,
Aromatic Commercial Beer.

| | Storage | |
|---|---|---|
| Sample | Condition | Results |
| J. 20 ppm CA | 1 week 40° C. | 8 of 8 panelists preferred |
| | | sample J to Aged |
| | | No Addition sample. |
| K. 20 ppm RA | 1 week 40° C. | 7 of 8 panelists preferred |
| | | sample K to Aged |
| | | No Addition sample. |
| K. 20 ppm RA | 3 days 40° C. | 6 of 8 panelists preferred |
| | | sample K to Aged |
| | | No Addition sample. |

Once again, in each case, the panelists showed a strong preference for the aged beer samples that had been treated with Labiatae herb extracts, over aged samples that had received no treatment. Treatment with Labiatae herb extracts or compounds derived from Labiatae herbs helped to preserve the fresh flavor of the beer. The treated beers were found to have less paper/cardboard flavors, be less sour and have less hang in bitterness.

### EXAMPLE 3

### Effect of Selected Labiatae Herb Extracts and Constituents on Flavor of a Light Beer Under Forced Aging Conditions

Separate solution of pure rosmarinic acid, pure carnosol and pure carnosic acid were prepared in ethanol as previously.

The light beer used in this study was approximately one month old and was purchased at a local market. Bottle additions were done as in Example 1.

The following samples were prepared:

| | |
|---|---|
| M. | 5 ppm CA (purified) |
| N. | 5 ppm RA (purified) |
| O. | 5 ppm CN (purified) |
| P. | No Additions |
| Q. | Fresh Control |

The bottles were placed in a heated room at 32±1° C. in the dark. After the allotted aging time, the bottles of beer were transferred to a dark refrigerator and stored at approximately 2° to 4° C. until they were analyzed. Additional bottles from the same code were kept unopened in 2° to 4° C. storage. These unopened samples from the same beer code were labeled “Fresh Control” used to provide fresh samples for the trained panel.

At the appropriate times, a trained 7-member panel evaluated the beers. In this study panel, the identity of the fresh sample was revealed to the panelists who used it to calibrate versus the aged beer. Five beers were evaluated at the session—Fresh Control, Aged No Addition, and Aged containing each one of the Labiatae treatments. The overall preference rank, the character and intensity of the aroma, the levels of paper/cardboard aroma and flavor, sour or off flavors, hang and astringency and bitterness quality and intensity were evaluated. The results are shown in Table 3.

TABLE 3
Enhancing Shelf life a Commercial Light Beer.

| | Storage | |
|---|---|---|
| Sample | Condition | Results |
| N. 5 ppm CA | 6 days 32° C. | 7 of 7 panelists preferred |
| | | sample N to Aged |
| | | No Addition sample, |
| | | and described it being |
| | | comparable to fresh. |
| O. 5 ppm RA | 6 days 32° C. | 7 of 7 panelists preferred |
| | | sample O to Aged |
| | | No Addition sample, |
| | | and described it being |
| | | comparable to fresh. |
| P. 5 ppm CN | 6 days 32° C. | 7 of 7 panelists preferred |
| | | sample P to Aged |
| | | No Addition sample, |
| | | and described it being |
| | | comparable to fresh. |

Once again, in each case, the panelists showed a strong preference for the aged beer samples that had been treated with Labiatae herb extracts, over aged samples that had received no treatment. Treatment with Labiatae herb extracts or compounds derived from Labiatae herbs helped to preserve the fresh flavor of the beer. These results show that aging of a light beer for six days at summer temperatures is enough to impair the flavor, and that the addition of low levels of CA, RA or CN very significantly retards the rate of staling.

### EXAMPLE 4

### Showing the Effect of Carnosic Acid on the Redox Potential of the Beer of Example 1

A 10 mg/mL solution of carnosic acid was prepared by taking 250 mg of 100% pure crystal by HPLC and diluting to a total volume of 25 mL with ethanol.

The bottle dosing process from Example 1 was modified to allow for the inclusion of air.
A bottle of the beer was opened, struck sharply on the top to induce foaming (called “fobbing”), and crowned. The fobbing excludes air. The bottle was swirled and inverted. This sample was designated No CA, No Air.
A bottle was opened and dosed with 7.1 mg of CA (20 ppm) to a 12 oz bottle from 710 μL of the above solution. After addition we gave the headspace two puffs of air, from a 25 mL squeeze bulb. The bottle was crowned, swirled and inverted without fobbing. The designation is 20 ppm CA, Plus Air.
A bottle was opened, but instead of fobbing, we gave the bottle two puffs of air of about 25 mL each from a squeeze bulb over the headspace. The bottle was then crowned. The bottle was swirled and inverted. This sample is “No CA, Plus Air.”

A standard solution of 2,4-dichloroindophenol sodium salt (DCIP) at a concentration of 145 mg/dL was prepared by the method described in Methodensammlung der Mitteleuropäischen Brautechnischene Analösen Kommission, Vierte Ausgabe 2002, Editor Prof. Dr. H. Miedaner, Weihenstephan, p. 104-107. 100 mg of DCIP was weighed in a beaker. 50 mL of de-ionized water was added and the mixture stirred for 20 min. The solution was filtered through Whatman #1 paper. 10 mL of the filtered DCIP was transferred by pipette to a 125 mL flask with 1.0 g KI and 2 mL of a solution made from 14.3 mL conc. H₂SO₄ brought to 100 mL in a volumetric flask. Four drops of starch indicator were added, and the DCIP was titrated with 0.01; sodium thiosulfate. The concentration of DCIP in mg/dL was measured by multiplying the mL of titer by 14.5. De-ionized water was added to adjust the final concentration to 1.45 mg/mL.

The beers were stored in a 39° C. box for 14 days. After the storage period the beer was removed from the hot room and refrigerated overnight. The beers to be analyzed (the four treatments above) were degassed by centrifuging at 6,000 rpm for 15 min. 10 mL of each degassed beer was transferred to a small 25 mL Erlenmeyer flask. Some of the degassed beer was poured to fill a 1 cm cuvette and placed in a spectrophotometer set to record the absorbance at 520 nm. The degassed “No CA, No Air” beer was used to set the baseline.

250 μL of adjusted DCIP was added to the 10 mL of degassed beer, the flask swirled to mix, and a 1 min timer started. The beer/DCIP was poured into a 1 cm cuvette and placed in the spectrophotometer. The absorbance was read at exactly 1 minute. These analyses were done in triplicate and averaged.

The “Redox Potential” was calculated by using the formula:

$$Rox = 100 \times ( 1 - ( \frac{{A}_{520}}{0.96} ) ) .$$

The results for this and other examples are summarized in Table 4, below.

TABLE 4
Redox Potential of the Beer of Example 1.
Effect of Carnosic Acid.

| Treatment | Redox Initial | Redox After 14 Days |
|---|---|---|
| No Additions, No Air | 36.7 | 39.7 |
| No CA, Plus Air | 36.7 | 0.0 |
| 20 ppm CA, Plus Air | 37.0 | 33.8 |

This shows that carnosic acid has significant preservative impact on a highly hopped beer.

### EXAMPLE 5

### Effect of Carnosic Acid Concentration on Redox Potential of a Semi-Light Beer and a Light Beer

The light beer was purchased at a local market and was 2 months old at time of use. Carnosic acid was added via a 1% ethanol solution made with pure CA. The levels of addition were 0, 5, 10, 15 and 20 ppm. The beers were opened, additions made and the beers were fobbed and crowned as described in Example 4. All analyses were done in triplicate using the DCIP method as described in Example 4. The samples were refrigerated for approx. 4 hr before being degassed and analyzed. The results are in the Table 5.

The same experiment was carried out with a semi-light beer with a production code indicating it was 5 months old.

TABLE 5
Effect of CA concentration on Redox Potential
in a Semi-Light and a Light Beer.

| Beer | Treatment | Storage Condition | Redox Potential |
|---|---|---|---|
| Light Beer | 0 ppm CA | 4 hr, 2-4° C. | 17.5 |
| ″ | 5 ppm CA | 4 hr, 2-4° C. | 28.1 |
| ″ | 10 ppm CA | 4 hr, 2-4° C. | 40.5 |
| ″ | 15 ppm CA | 4 hr, 2-4° C. | 51.6 |
| ″ | 20 ppm CA | 4 hr, 2-4° C. | 67.4 |
| Semi-light Beer | 0 ppm CA | 4 hr, 2-4° C. | 38.0 |
| | 5 ppm CA | 4 hr, 2-4° C. | 47.4 |
| | 10 ppm CA | 4 hr, 2-4° C. | 56.6 |
| | 15 ppm CA | 4 hr, 2-4° C. | 64.8 |
| | 20 ppm CA | 4 hr, 2-4° C. | 73.9 |

### EXAMPLE 6

### Effect of Carnosic Acid and Rosmarinic Acid on Redox Potential, DPPH Radical Scavenging and Color in the Highly Hopped Beer of Example 4

Solutions of rosmarinic acid and carnosic acid (2% w/v) were prepared separately by dissolving the purified additive (500 mg) in 25 mL of 100% ethanol. The bottle dosing methods used were the same as those described in Example 1. The following samples were made:
1. 20 ppm Carnosic Acid
2. 20 ppm Carnosic Acid plus Air
3. 20 ppm Rosmarinic Acid
4. 20 ppm Rosmarinic Acid plus Air
5. 10 ppm Carnosic Acid+10 ppm Rosmarinic Acid
6. 10 ppm Carnosic Acid+10 ppm Rosmarinic Acid+Air
7. No Additions plus Air
8. No Additions.

Treatments 1 through 8 were put in a temperature regulated room set at 40° C. and maintained at ±1° C. At intervals of Zero time, 3 days, 7 days, 14 days, and 21 days, samples were withdrawn and Redox Potentials were measured by the method outlined in example 4. Color measurements were made using the L, a, b system on a Minolta Spectrophotometer model CM-3500d. L, a, b, chroma and hue angle color measure units were recorded. DPPH radical scavenging numbers were measured using the following method. A de-ionized-H₂O/EtOH buffer solution was prepared by dissolving 250 mg sodium citrate dihydrate and 10 g of absolute ethanol in 250 mL of deionized water. The solution was then titrated with 0.1 N Citric acid (6.404 g/L anhydrous citric acid) a drop at a time to reach a pH of between 4.35 and 4.5.

To perform the test, about 0.04 g of DPPH was weighed to the nearest 0.1 mg in a 100 mL volumetric, recording the exact weight of DPPH. The DPPH was dissolved in methanol and methanol was added to bring the volume to the 100 mL mark. The solution was sonicated to facilitate dissolution. The beers to be measured were opened and 12 mL of each was poured into separate 15 mL centrifuge tubes, making sure that the volumes in all tubes were equal. The analyses were done in triplicate for each beer. An extra beer sample served as a spectrophotometer blank. The beer was degassed by centrifuging it for 15 min at 6,000 rpm. Into each of two 25 mL flasks was pipeted 5 mL of the pH 4.5 water-ethanol buffer. The spectrophotometer wavelength was set to 531 nm and a buffered water blank was zeroed. 1.0 mL of DPPH solution was added to the water buffer, which was swirled at the same time a timer was started. Just before 10 minutes had elapsed, the sample was transferred to a cuvette and the absorbance (A_{BL}) was measured. The analysis was duplicated with another buffer. For accuracy it is necessary that great care be taken to add exactly 1 mL reagent. It is also important to swirl (mix) the samples consistently as the assay is sensitive to oxygen and to the amount of reagent used. Degassed beer was used to obtain a baseline at 531 nm. After centrifugation 5 mL of the beer was transferred into the appropriate labeled 25 mL flask. 1.0 mL of DPPH solution was added, the solution was swirled and the timer was started. The Absorbance (A₅₃₁) of the beer sample was recorded. This process was repeated for all samples. To eliminate any possible prejudice in order of analysis, samples were analyzed randomly. The following formula was used to calculate the amount of DPPH which reacts with 5 mL of beer:
μmol DPPH=((1−A₅₃₁/A_{BL})×(g DPPH/394))×10⁶

The results of this study are summarized in Table 6, below.

TABLE 6
Effect of Labiatae Constituents on Redox Potential and Color in the Highly
Hopped Beer of Example 4.

| | | DCIP | | | | | | |
|---|---|---|---|---|---|---|---|---|
| | | Redox | DPPH | L* | | | | |
| Beer + Treatment | Days | Value | Number | Value | a* Value | b* Value | c* Value | h Value |
| No Addns | 0 | 75.7 | 44.8 | 85.42 | 2.21 | 46.23 | 46.29 | 87.27 |
| | 3 | 65.1 | 53.8 | 84.10 | 2.14 | 46.41 | 46.46 | 87.37 |
| | 7 | 75.1 | 65.3 | 86.03 | 3.59 | 55.35 | 55.45 | 86.29 |
| | 14 | 55.7 | 61.7 | 85.58 | 4.20 | 56.37 | 56.53 | 85.74 |
| | 21 | 60.0 | 59.5 | 85.24 | 3.99 | 56.11 | 56.25 | 85.94 |
| 20 ppm | 0 | 90.6 | 52.2 | 87.62 | 2.30 | 49.84 | 49.84 | 87.36 |
| CA | 3 | 89.1 | 69.8 | 81.77 | 2.19 | 42.27 | 42.32 | 87.00 |
| | 7 | 83.5 | 64.7 | 86.53 | 3.51 | 55.71 | 55.82 | 86.40 |
| | 14 | 82.3 | 64.4 | 86.33 | 3.67 | 56.68 | 56.80 | 86.30 |
| | 21 | 86.9 | 60.5 | 84.30 | 3.78 | 53.35 | 53.49 | 85.95 |
| 20 ppm | 0 | 93.8 | 53.3 | 85.79 | 2.02 | 42.69 | 40.73 | 87.30 |
| CA + Air | 3 | 89.1 | 67.2 | 82.05 | 2.94 | 47.61 | 47.70 | 86.47 |
| | 7 | 68.9 | 55.6 | 84.76 | 4.30 | 55.47 | 55.67 | 85.57 |
| | 14 | 62.1 | 61.7 | 84.67 | 4.73 | 56.79 | 57.04 | 85.24 |
| | 21 | 62.9 | 56.5 | 82.46 | 5.23 | 55.19 | 55.58 | 84.60 |
| 20 ppm | 0 | 76.3 | 51.8 | 85.30 | 2.10 | 40.47 | 40.52 | 87.03 |
| RA | 3 | 76.2 | 66.3 | 81.68 | 2.29 | 44.63 | 44.69 | 87.07 |
| | 7 | 63.9 | 58.7 | 86.15 | 3.51 | 55.34 | 55.45 | 86.37 |
| | 14 | 59.9 | 63.7 | 86.12 | 3.70 | 55.84 | 55.95 | 86.21 |
| | 21 | 63.4 | 57.5 | 83.94 | 3.96 | 53.00 | 53.17 | 85.73 |
| 20 ppm | 0 | 76.0 | 49.9 | 85.69 | 2.74 | 46.57 | 46.65 | 86.64 |
| RA + Air | 3 | 63.4 | 67.1 | 76.33 | 4.04 | 49.60 | 49.76 | 85.35 |
| | 7 | 48.3 | 57.7 | 84.20 | 4.97 | 56.09 | 56.30 | 84.93 |
| | 14 | 25.1 | 56.3 | 82.42 | 6.75 | 59.30 | 59.68 | 83.50 |
| | 21 | 26.6 | 50.5 | 80.14 | 7.28 | 58.03 | 58.39 | 82.84 |
| 10 ppm CA + 10 ppm | 0 | 85.2 | 48.5 | 84.29 | 2.19 | 47.77 | 47.82 | 87.38 |
| RA | 3 | 66.3 | 86.0 | 82.98 | 2.13 | 43.74 | 43.79 | 87.20 |
| | 7 | 75.4 | 62.0 | 85.36 | 3.66 | 55.13 | 55.25 | 86.20 |
| | 14 | 72.7 | 64.8 | 85.62 | 3.68 | 52.88 | 53.00 | 86.03 |
| | 21 | 75.2 | 61.1 | 85.24 | 4.23 | 57.01 | 57.17 | 85.77 |
| 10 ppm | 0 | 82.4 | 52.4 | 85.81 | 2.51 | 47.88 | 47.95 | 86.99 |
| RA + 10 ppm | 3 | 66.3 | 76.7 | 81.62 | 3.33 | 47.73 | 47.84 | 86.01 |
| CA + Air | 7 | 48.2 | 56.1 | 82.70 | 5.65 | 55.53 | 55.81 | 84.22 |
| | 14 | 50.9 | 60.4 | 84.25 | 4.95 | 54.12 | 56.34 | 84.95 |
| | 21 | 33.7 | 52.6 | 79.85 | 7.31 | 57.97 | 58.43 | 82.81 |
| Air, no | 0 | 82.5 | 53.6 | 85.02 | 3.50 | 52.34 | 52.46 | 86.17 |
| other | 7 | 19.7 | 42.6 | 80.54 | 6.80 | 52.52 | 52.97 | 86.60 |
| Additions | 14 | 17.8 | 41.8 | 80.25 | 6.50 | 48.70 | 49.13 | 87.40 |

The redox potential of beer decreases with increased aging time and air has a dramatic negative effect on it. Carnosic acid increases the DCIP redox potential of the starting beer and has a dramatic effect on preserving the DCIP redox potential over time. Rosmarinic acid has no effect on the DCIP redox potential or on the preservation of redox potential in this particular beer. The mixture of carnosic acid and rosmarinic acid does not enhance the redox potential of the fresh beer, but dramatically preserves the redox potential during aging. Carnosic acid shows a beneficial effect on aged beer that contains added air. The DCIP redox potentials at the end of the test are higher for CA treated beers. Rosmarinic acid is not effective in preserving the DCIP redox potential in beers that have been contaminated by air. Neither CA nor RA has much impact on DPPH numbers in beers that have not been treated with air. CA, RA and the mixture of CA and RA preserves the DPPH number in beers that have been treated with air. Table 6 shows that additives and air have an effect on the color of aged beer, especially on the color value known as a*. Beer exposed to air shifts in “a*” value rapidly. RA does not appear to do anything to prevent that air-induced color change, but CA does have a positive effect.

### EXAMPLE 7

### The Effect of Carnosol on the Redox Potential of the Light Beer of Example 3

A 2% solution of carnosol, isolated from sage extract, was prepared by weighing 200 mg pure carnosol and bringing to 10 mL with pure ethanol. Bottles were dosed at 10 and 20 ppm carnosol with our standard bottle addition technique of opening, fobbing to exclude air, and crowning.

Bottles were stored at 2 to 4° C. for 1 day before analysis. Standard DCIP and DPPH measurements were taken. Table 7, below summarizes the results.

TABLE 7
Effect of Carnosol on Redox Potential of
A Commercial Light Beer

| Treatment | DCIP Redox Potential | DPPH No. |
|---|---|---|
| No Addition | 22.7 | 38.8 |
| 10 ppm Carnosol | 19.6 | 33.1 |
| 20 ppm Carnosol | 19.6 | 37.0 |

Surprisingly, carnosol does not enhance the redox potential of beer as measured by the DCIP method. Carnosol does not enhance a beer's ability to reduce DPPH. We have found that Carnosol at 5 ppm in beer does have a significant, positive impact on preserving fresh flavor. The mechanism by which it performs is not known.

### EXAMPLE 8

### Example of a Mixture of Carnosic and Rosmarinic Acids on the Preservation of Isohumulone

The beer of Example 1, with a production code indicating that it was 27 days old at the time it was purchased was used for this example. One case of bottles was opened, 20 ppm carnosic acid and 20 ppm rosmarinic acid in the form of a propylene glycol solution was added and the bottles fobbed and crowned according to the procedure detailed in Example 1. An additional case was opened, fobbed and crowned in the same manner, and designated “Control”. All bottles were put in a 40° C. temperature controlled hot room. Samples of the above beer were taken at 0 time, 7, 21, 35, 44 and 58 days for HPLC hop acid analysis by a modification of the method of Burroughs and Williams [1999]. Beer samples (100 mL) were gently poured into tall-form beakers to avoid excessive foaming. Octanol (1-2 drops) was added to minimize foam, and the beer was sparged with helium for 10-15 minutes to degas them. The degased beer was transferred to a 2 mL autosampler vial and assayed according to the method in the reference.

Recent literature, Araki, et al. [2002] and L. De Cooman et al. [2001] shows evidence that trans isomers of iso-alpha acids are indicators of beer aging. The level of trans declines faster than the level of cis isomers. The trans isomers in this example are 28% of the total hop acids. The effect of added Labiatae herb extract constituents on the cis/trans ratio of the isohumulones in beer is shown in Table 8.

TABLE 8
Cis/Trans Ratios of Isohumulone in Beer with and without
Labiatae herb constituents. Effect of storage at 40° C.

| | No | | 20 ppm CA + |
|---|---|---|---|
| Day | Addition | 20 ppm CA | 20 ppm RA |
| 0 | 2.548 | 2.699 | 2.578 |
| 7 | 3.206 | 2.850 | 2.805 |
| 21 | 4.263 | 3.947 | 4.003 |
| 35 | 6.278 | 5.450 | 6.174 |
| 44 | 8.351 | 7.974 | 6.067 |
| 58 | 9.913 | 9.863 | 7.461 |

Carnosic acid performed up to about 35 days in helping to maintain the cis/trans level. The mixture of carnosic acid and rosmarinic acid had an even higher preserving effect on the cis/trans ratio. It is important to note that this effect may be unrelated to the flavor staling described in Examples 14. The measurable effect noted in the cis/trans ratio is not evident until after a few weeks of aging, whereas the flavor changes occur much earlier than that. This example portrays the synergistic effect of RA and CA. The synergy also occurs with CN.

### EXAMPLE 9

### The Effect of CA and RA on the Redox Potential of Mash

A 300 g sample of 2-row Pale Barley Malt obtained from a local brewery was ground to a “brewery grind” with a hand grinder. Fifty-gram samples of the ground malt were weighed into each of three 600 mL beakers. Tap water was boiled for 5 min to remove the chlorine and sanitize the water. When cooled, the pH of the water was adjusted from 7.86 to 5.5 with 0.1 N H₂SO₄. The water was then heated to 43° C. (109.4° F.) and 160 g of this adjusted water was added to each beaker. To one of the beakers was added 210 μL of a 2% solution of carnosic acid in ethanol (giving 20 mg CA/kg of mash). To another beaker was added 210 μL of a 2% solution of rosmarinic acid. One beaker received no treatment. The beakers were stirred for 10 min at 43° C. on a temperature probe controlled hot plate, with the probe in one of the beakers. After the 10 min period the beakers were placed on another temperature probe controlled hot plate set at 68° C. (154.4° F.), and the probe put in one of the mash beakers. The come up time was approximately 15 min from 43° C. to 68° C. The beakers were stirred at this temperature for 15 min. After the 15-minute mash, the beakers were removed from the hot plate and cooled in an ice bath. Each beaker's contents were strained through a paper filter. Approximately 75 mL of first wort was collected from each mash. The grain was not sparged. The °Balling of the worts was measured with a temperature-compensated refractometer (Abbe, Leica Mark II). The DCIP reducing power of each wort was analyzed, in duplicate, with the standard method described previously. The results are shown in Table 9.

TABLE 9
Effect of CA and RA on the Redox Potential of Mash.

| Treatment | Degrees Balling | Redox |
|---|---|---|
| No additions | 11.9 | 0.0 |
| 20 ppm CA | 11.7 | 17.3 |
| 20 ppm RA | 12.6 | 38.8 |

RA has been shown to have only a small if any effect in enhancing the redox potential of beer. CA was shown to be the more powerful additive in this respect. In the case of malt, RA is seen to be the compound having the major enhancing effect. This may be the reason that RA added early in the brewing process has an enhancing effect. CA has an enhancing effect as well, but it is less by about half the effect seen with RA.

### EXAMPLE 10

### A Unique Combination of Hop Bitter Acids and Labiatae Herb Constituents Suitable for Convenient Addition of Bittering and Stabilizing Agents to Beer, Post-Fermentation

A solution of rosmarinic acid in 9.5% tetrahydroisohumulone at pH 8 was prepared and allowed to stand at room temperature for an extended period of time to determine stability. The RA is stable in this formulation for at least three months. The results are shown in Table 10.

TABLE 10
Concentration of RA in tetrahydroisohumulone
as a function of time.

| Time in Days | % Rosmarinic Acid in Solution |
|---|---|
| 0 | 12.07 |
| 3 | 12.45 |
| 5 | 12.40 |
| 15 | 12.12 |
| 38 | 11.36 |
| 54 | 11.74 |
| 86 | 10.88 |

The RA is very stable in the hop acid solution. Solutions of CA, RA and CN can be prepared in a variety of hop acids, limited only by solubility. The hop acids can include isohumulones, dihydro-isohumulones, tetrahydro-isohumulones, and hexahydro-isohumulones, or any combination. These compositions provide a very convenient way of adding both bitterness and flavor stability to a beer. The lower the pH, the greater will be the stability. While this example shows a preferred upper limit, the most preferred pH range is about 6 to 7.5, although ranges down to pH 3.5 are acceptable is the storage time is not long and the mixture kept cool. All of the mixtures may be dosed into beer at a pH of 10 when diluted in alkaline water.

### EXAMPLE 11

### Effect of Labiatae Herb Extracts on Redox Potential During Pasteurization

Five bottles of a commercial light beer, 81 days old at the time of the experiment, but having been stored at 2° C. were used in this experiment. The following five treatments were prepared:
1. An unpasteurized control was prepared by leaving one bottle unopened in the refrigerator until analysis.
2. Another bottle was opened, 20 ppm carnosic acid was added from a solution made from pure material, and the bottle fobbed and crowned. This sample was also not pasteurized.
3. A bottle was opened, fobbed to exclude air, and crowned. This sample is designated the No Addition Pasteurized Control.
4. A bottle was opened and 20 ppm carnosic acid was added from a solution made from pure compound. The bottle was fobbed and crowned and subjected to pasteurization.
5. A bottle was opened and 20 ppm of rosmarinic acid was added from a solution of pure compound. The bottle was fobbed and crowned and subjected to pasteurization.

Treatments 3, 4, and 5 were immersed in an ambient temperature water bath and heated to 60° C. The approximate time to reach 60° C. from ambient was 12 minutes. The bottles remained at 60° C. for 12 minutes. They were then removed and cooled. All five treatments were analyzed by the DCIP-Redox method described in Example 4. The results are shown in Table 11:

TABLE 11
Effect of CA and RA on Redox Potential of Pasteurized Beer.

| Sample No. | Treatment | Redox Potential |
|---|---|---|
| 1 | Initial, No Additions, no | 17.5 |
| | pasteurization | |
| 2 | +20 ppm CA, no pasteurization | 67.4 |
| 3 | No Addn Control, pasteurized | 13.4 |
| 4 | +20 ppm CA, pasteurized | 45.0 |
| 5 | +20 ppm RA, pasteurized | 13.4 |

These results show the protective power of CA. The reducing power of the beer is held at a higher level than the untreated, unpasteurized control. Rosmarinic acid shows no potential to preserve the redox potential of beer during pasteurization.

### EXAMPLE 12

### Showing the Beneficial Effect of Adding Labiatae Herb Extracts, Carnosic Acid, Carnosol or Rosmarinic Acid or combinations thereof Prior to Malting

Barley is treated with an aqueous solution of a Labiatae herb extract containing rosmarinic acid. In a separate test, barley is treated with an aqueous suspension of a Labiatae herb extract containing carnosic acid and carnosol. The latter extract is incorporated with a food grade emulsifier to make it more easily dispersed. Enough of each extract solution or suspension is added separately to the barley to bring the moisture level of the grain to 14-15%. The concentration of the extract solution and suspension is such that the addition results in a final concentration of between 10 and 250 ppm of carnosic acid, carnosol or rosmarinic acid. The grain is malted by means known to the art. The malt is kilned and mashed and the mash is used to prepare wort. The redox potential of the mash and wort are higher in the treated tests relative to a control in which only water is added during the malting. Beer prepared from the test compositions retains its fresh flavor longer than beer prepared from the control. A similar result is obtained when barley is treated with aqueous solutions or suspensions of rosmarinic acid, carnosol or carnosic acid, or any combination of the three.

### EXAMPLE 13

### Measurement of Aged Flavor Improvement in a Pilot Brewery Beer Treated with Carnosic Acid and Rosmarinic Acid in the Brewing Process. Multiple Treatment and Order of Addition

Beer was brewed in a commercial pilot brewery as described below.

Mash In

3.85 Kg of Breiss 2 row pale malt was wetted with 50-60 ml of water spray and ground through two roller mill rollers set at 0.025 inch. The ground grain was added to 16 liters of filtered brew water at 130° F. The pH adjusted to 5.1 to 5.4 with 75% phosphoric acid.

Mash Program

The mixed water/grain or “mash” was held at 122° F. for 10 minutes with agitation. The first rosemary extract compound (RA or CA) in ethanol was added at mash in. The carnosic acid/rosmarinic acid composition additions, including control, are summarized in Table 12. The CA and RA solutions were adjusted for purity. The “Mash-In” sample was removed at this point for Reducing Power (DCIP), % RA, % CA and % CN analysis. These results and those of other sampling points later in the process are summarized in Table 13. After a 10 min hold, the mash was ramped to 145° F in 11 minutes at 2 degrees per minute. The mash was held at 145° F. for 45 minutes. The mash was ramped to 155° F. in 5 minutes at 2 degrees per minute. The mash was held at 155° F. for 30 minutes with agitation. After a 30 min hold, the mixture temperature was raised to 170° F. in 7 minutes at 2 degrees per minute and held at 170° F. for 10 minutes.

TABLE 12
A summary of treatment additions.

| | | Target | | | | |
|---|---|---|---|---|---|---|
| | | ppm | | Target ppm | | Target ppm |
| | Addition at | added at | Addition at | added at Sparge | Addition at | added at Kettle |
| Treatment | Mash In | Mash In | Sparge Water | Water | Kettle Boil Start | Boil Start |
| Control | 100 ml | | 100 ml Ethanol | | 100 ml Ethanol | |
| | Ethanol | | | | | |
| RA/CA | 2.22 g | 100 ppm | 0.55 g | 25 ppm | 0.37 g carnosic | 10 ppm |
| | rosmarinic | | rosmarinic acid | | acid in 100 ml | |
| | acid @ 90% | | in 100 ml | | Ethanol | |
| | purity in 100 ml | | Ethanol | | | |
| | Ethanol | | | | | |
| CA/RA | 2.0 g | 100 ppm | 2.0 g carnosic | 100 ppm | 0.82 g | 20 ppm |
| | carnosic | | acid in 100 ml | | rosmarinic acid | |
| | acid in 100 ml | | Ethanol | | in 100 ml | |
| | Ethanol | | | | Ethanol | |

TABLE 13
DCIP, ppm RA, CA and CN Measurement Data for Various Sample Points.

| | Average | | | | | | | | |
|---|---|---|---|---|---|---|---|---|---|
| | Control | RA/CA Brew | | | | CA/RA Brew | | | |
| Stage | DCIP | DCIP | RA ppm | CA ppm | CN ppm | DCIP | RA ppm | CA ppm | CN ppm |
| Mash-In | 7.60 | 9.70 | 52.58 | | | 16.00 | | 3.51 | 1.56 |
| Last | −3.50 | 6.70 | 24.55 | | | 0.40 | | 0.28 | 4.89 |
| Runnings | | | | | | | | | |
| Vorlauf | 13.00 | 28.20 | 28.82 | | | 14.10 | | 0.19 | 0.94 |
| Start of | −1.50 | 5.60 | 19.77 | | | 0.90 | | 0.22 | 2.57 |
| Boil | | | | | | | | | |
| End of Boil | 7.50 | 16.20 | 22.10 | 4.61 | 1.19 | 3.00 | 20.78 | 0.27 | 2.42 |
| Wort Settle | 7.60 | 18.60 | 22.33 | 6.73 | 1.08 | 3.00 | 20.88 | 0.49 | 2.87 |
| Trub | 7.00 | 19.60 | 21.12 | 2.92 | 0.50 | 10.90 | 19.97 | 0.33 | 1.20 |
| Liquid | | | | | | | | | |
| Fermenter | 6.50 | 21.40 | 22.25 | 4.73 | 0.69 | 6.30 | 21.40 | 0.38 | 1.89 |
| Day “0” | | | | | | | | | |
| Diacetyl | 8.90 | 11.10 | | | | 5.70 | | | 0.00 |
| Rest | | | | | | | | | |
| Maturation | 9.60 | 12.70 | 24.33 | 0.46 | 0.15 | 15.50 | 24.33 | 0.00 | 0.85 |

Wort Straining

The mash was then dropped to Lauter Tun and allowed to settle for 30 minutes undisturbed. Once the grain was transferred, the Lauter was “Vorlauffed” (wort was drawn from the bottom and recirculated to the top in spray form) for 30 minutes or until runnings were clear. The “Vorlauf” sample was removed at this point for DCIP, % RA, % CA and % CN analysis and the results are summarized in Table 13. Once clear, the liquid was pumped into the bottom of the brew kettle at 150° F. Meanwhile, 20 Liters of sparge water was preheated to 170° F. and adjusted to pH 5.1 to 5.4 with 75% phosphoric acid. This “sparge water” was sprayed over the top of the grain bed just before the grain showed through the surface of the first wort. The second rosemary extract compound (RA or CA) in ethanol was added to the sparge water prior to spraying. All additions are summarized in Table 12. The last runnings were terminated at 3° Brix measured by refractive index. Spent grain was sampled for assay and disposed of. The “Last Runnings” sample was removed at this point for DCIP, % RA, % CA and % CN analysis and the results are summarized in Table 13.

Kettle Boil

Approximately 11-12 liters of filtered brewing water was added to the brew kettle, making gravity 5.5 to 6.5° Brix. The brew kettle was set to a rolling boil with lid off for 90 minutes. At beginning of boil 0.2 g of a hop derived non-acidic resin code and 2.6 g of isohumulones were added. The “Start Boil” sample was removed at this point for DCIP, % RA, % CA and % CN analysis and the results are summarized in Table 13. The third rosemary extract compound (RA or CA) in ethanol was added to the brew kettle at the beginning of kettle boil. All additions are summarized in Table 12. Twenty minutes before the end of the kettle boil, 1.6 Kg of liquid brewer's syrup 60/44 IX was added to the boiling wort. After the heating was stopped, the “End Boil” sample was removed for DCIP, % RA, % CA and % CN analysis. The results are summarized in Table 13. The kettle was allowed to cool undisturbed to about 180° F. for one hour. The Brix of the wort was taken at this point and was in an acceptable range of 10.8 to 11.2. The “Wort Settle” sample was removed at this point for DCIP, % RA, % CA and % CN analysis and the results are summarized in Table 13.

Wort Cooling

Using a MasterFlex peristaltic pump the wort was pumped through a heat exchanger and cooled to 45-50° F. while being aerated with bottled medical grade air, filtered through a Gelman 0.2 um filter. The wort was drawn off above the bottom of the kettle to avoid taking hot trub.

Fermentation and Maturation

Wyeast yeast strain 2007 (300 mL) was added to the aerated wort in a fermenter. The “Fermenter” sample was removed at this point for DCIP, % RA, % CA and % CN analysis and the results are summarized in Table 13. Primary fermentation temperature was 50° Brix. During fermentation the beer was sampled daily for pH and gravity readings. The fermenting wort was held in a water bath at 50° F. for 5-7 days or until the gravity dropped to 3.3-3.6° Brix. The fermenter was then moved to a 60° F. water bath and the “Diacetyl Rest” sample was removed at this point for DCIP, % RA, % CA and % CN analysis. The results are summarized in Table 13. The fermenter was kept in the 60° F. water bath for three days for diacetyl rest. The beer was then transferred to a sanitized tank that had been filled with sterile water. Prior to transfer the tanks was blown out with CO₂ to insure that there was no oxygen left in the keg. The keg was stored at 45° F. for 7 days for maturation. The “Maturation” sample was removed at this point for DCIP, % RA, % CA and % CN analysis and the results are summarized in Table 13. The keg was then transferred to cold storage for 10 days of aging at 32° F.

Finishing

After cold storage, the beer was filtered using a Cuno filter housing and a Cuno 70-H four disc filter into a sanitized tank that had been filled with sterile water and blown out with CO₂. This “bright beer” was carbonated at 12 psi for 25 minutes and stored at 38° F with a CO₂ head space.

Aging

The kegs were then transferred to a walk-in hot box set at 32° C. for aging. The beers were sampled by a sensory a panel after 5 and 7 days. The sensory panel was a highly trained panel, having performed over 100 hours of training, much in staling and other flavor characters. After 7 days of aging, the kegs were cooled to 35° F. prior to sampling by the panel.

The data in the table show the addition of rosmarinic acid to the beginning of Mash In preserves reducing power at this stage. The literature shows that hydro peroxides of linoleic and linolenic acids are formed at this stage. (Kobayashi, Naoyuki, et. al. Journal of Fermentation and Bioengineering vol76(5), 371-375, 1993: Araki, Shigeki, et. al. J. Am. Brew. Soc. 57(!), 34-37, 1999). The addition of RA at this point maintains positive reducing power, even though RA itself is not reactive with DCIP and the wort has not yet developed inherent reducing power.

Sensory Results

The Sensory Panel was made up of 20 individuals who had undergone 100 hours of professional training, mostly in flavors attributed to staling. The sensory data were taken in the following manner. Each treatment sample was presented to the panelists one time each in three different sessions for a total of three replicates for each sample. Panelists rated the beers on a scale of 0-10, with 0 being fresh and 10 being most stale. Since the output of the panel as a whole was desired, and not any one individual panelist, the means of each treatment sample in each replicate groups were calculated and tabulated as in Table 14 in the columns “Rep 1”, “Rep 2” and “Rep 3”. The mean of these “Reps” was calculated and tabulated in Table 14 under the column heading “Mean”. Samples spiked with known amounts of off-flavors characteristic of aged pilot brewery beer were used as reference beers. This characterization was done in a separate descriptive session. The characteristic off-flavors in the pilot brewery beer were papery and acetaldehyde and these were each spiked into fresh control beer at 0.75 and 1.5 times the typical flavor threshold. Any panelist not getting the spikes ranked in the right order had their data removed from the analysis, since it indicated that they were not performing well for that attribute in that session.

Since each beer was brewed separately, the 2 controls were combined into an average set of data called “Average Control” to better approximate what an average control would look like. All comparisons done vs. control were done using the “Average Control” data.

Statistical analysis consisted of doing paired t-Tests on the three replicates of any one treatment sample vs. the three replicates on another, with replicate 1 of treatment sample 1 being compared to replicate 1 of treatment sample 2 (Table 15). One-tailed tests were used that probed the question whether the staling values of one treatment were statistically different than that of the other (e.g treatment vs. control). Confidence levels were reported along with p values.

TABLE 14
Panel Staling Scaling Data.

| | | Rating data (outliers removed) | | | | |
|---|---|---|---|---|---|---|
| Treatment | | Rep 1 | Rep 2 | Rep 3 | Mean | Std. Dev. |
| Average Control | Fresh | 1.227 | 1.375 | 1.136 | 1.246 | 0.12 |
| | Aged | 4.864 | 4.531 | 4.864 | 4.753 | 0.19 |
| Test 1 | Fresh | 1.273 | 1.625 | 1.273 | 1.390 | 0.20 |
| RA followed by CA | Aged | 4.545 | 4.500 | 4.091 | 4.379 | 0.25 |
| Test 2 | Fresh | 2.545 | 2.063 | 1.727 | 2.112 | 0.41 |
| CA followed by RA | Aged | 6.455 | 5.563 | 5.545 | 5.854 | 0.52 |

| | | | | | |
|---|---|---|---|---|---|
| Ref level 1 (0.75x papery + | 2.545 | 2.625 | 2.455 | 2.542 | 0.08 |
| 0.75x acetaldehyde) | | | | | |
| Ref level 2 (1.5x papery + 1.5x | 6.273 | 6.375 | 5.636 | 6.095 | 0.40 |
| acetaldehyde) | | | | | |

TABLE 15
Comparison of Selected Samples Using Paired t-Test.

| Test Pair (Using Average Controls) | Confidence Level | p Value |
|---|---|---|
| Aged RA followed by CA vs. Aged Control | 88.74% | 0.1126 |
| 1.5x Spike (Ref level 2) vs. Cold Control | 99.94% | 0.0006 |
| 0.75x Spike (Ref level 1) vs. Cold Control | 99.98% | 0.0002 |
| 1.5x vs. 0.75x Spike | 99.86% | 0.0014 |
| Aged Control vs. Fresh Control | 99.87% | 0.0013 |
| Fresh RA followed by CA vs. | 93.23% | 0.0677 |
| Fresh Control (RA/CA) | | |
| Fresh CA followed by RA vs. | 96.85% | 0.0315 |
| Fresh Control (CA/RA) | | |

A lipophilic rosemary extract can be substituted for the carnosic acid and a hydrophilic rosemary extract can be substituted for the rosmarinic acid in this example, with similar results, provided that the extracts are used in an amount sufficient to match the levels of carnosic acid and rosmarinic acid noted above.

### EXAMPLE 14

### Measurement of Aged Flavor Improvement in Beer Treated with Carnosic Acid and Rosmarinic Acid in Bottled Beer

A standard American lager and a light lager were purchased commercially. The treatment bottles were opened, dosed, fobbed, crowned and inverted. The control bottles were opened, crowned and inverted. The antioxidant treatments used are summarized in Table 16. Dosing was performed as follows. One gram of pure antioxidant (corrected for actual purity) was dissolved in 100 mL ethanol and sonicated to make the antioxidant solutions of 1 weight/volume %. The volumes shown in Table 16 show the amount of the antioxidant solutions added to obtain a total of 10 ppm carnosic acid and/or rosmarinic acid in the final beverage formulations.

TABLE 16
An outline of antioxidant treatments used

| | | Target level of |
|---|---|---|
| | Amount of Antioxidant | Antioxidant in finished |
| Antioxidant (Source) | Solution (1% w/v) Added | product |
| Control | 0 | 0 |
| Carnosic Acid (Bridge | 355 μl | 10 ppm |
| Organics) | | |
| Rosmarinic Acid | 355 μl | 10 ppm |
| (Furfural) | | |
| Carnosic Acid (CA) + | 177 μl CA + 177 μl RA | 5 ppm CA + |
| Rosmarinic | | 5 ppm RA |
| Acid (RA) | | |

The sensory data were taken in the following manner. Each treatment sample was presented to the panelists one time each in two different sessions each at a different amount of aging time (5 vs. 10 days). Panelists rated the beers on a scale of 0-10, with 0 being fresh and 10 being most stale. Since the output of the panel as a whole was desired, and not any one individual panelist, the means of each treatment sample in each replicate groups were calculated and tabulated as in Table 17. Samples spiked with known amounts of off-flavors characteristic of the aged standard American lager were used as reference beers. This characterization was done in a separate descriptive session. The characteristic off-flavors in the pilot brewery beer were papery and leathery, and these were each spiked into fresh control beer at 0.75 and 1.5 times the typical flavor threshold. Any panelist not getting the spikes ranked in the right order had their data removed from the analysis, since it indicated that they were not performing well for that attribute in that session.

Statistical analysis consisted of doing paired t-Tests on the treatment sample vs. the aged control sample (Table 18). One-tailed tests were used that probed the question whether the staling values of one treatment were lower than that of the other (e.g treatment vs. control). Confidence levels were reported along with p values.

TABLE 17
Panelist Averages for Standard American Lager
Treated vs. Control Beers.

| | Day 5 | Day 10 |
|---|---|---|
| Sample | Average | Average |
| Fresh Control | 1.89 | 1.75 |
| Aged Control | 4.22 | 4.375 |
| Fresh CA | 2.89 | 2.25 |
| Aged CA | 3.00 | 4.375 |
| Fresh RA | 0.78 | 2.5 |
| Aged RA | 3.22 | 2.75 |
| Fresh RA/CA | 1.22 | 2.875 |
| Aged RA/CA | 3.11 | 3.25 |
| 0.75x Papery + 0.75x | 3.56 | 3.625 |
| Leathery | | |
| 1.5x Papery + 1.5x | 6.56 | 5.75 |
| Leathery | | |

TABLE 18
Comparison of Standard American Lager
Treated vs. Aged Control Samples
Using Paired t-Test.

| | Confidence | | |
|---|---|---|---|
| Test Pair | Level* | p Value | Days Aged |
| Aged RA vs. Aged Control | 90.25% | 0.0975 | 5 |
| Aged CA vs. Aged Control | 94.44% | 0.0556 | 5 |
| Aged CA/RA vs. Aged Control | 84.93% | 0.1507 | 5 |
| Aged RA vs. Aged Control | 90.00% | 0.1000 | 10 |
| Aged CA vs. Aged Control | 50.00% | 0.5 | 10 |
| Aged CA/RA vs. Aged Control | 85.75% | 0.1425 | 10 |

### EXAMPLE 15

### Showing the Beneficial Effect of Adding a hop Bitter Acid/Rosmarinic Acid, Hop Bitter Acid/Carnosic Acid, Hop Bitter Acid/Carnosol or Hop Bitter Acid/Combination Labiatae Phenolic compound Composition

Freshly brewed beer is treated with the compositions of Example 10 immediately prior to pasteurization in amounts necessary to effect the desired bitterness and shelf life improvements. The beers produced retain their fresh flavors longer than beers produced with added hop bitter acids alone.

### EXAMPLE 16

### Compositions of Hop Oil and Labiatae Herb Constituents

Hop oil is distilled from whole hops or from hop extracts by methods known in the art. The hop oils can be further purified by methods known in the art. Hop oil/Labiatae herb compositions are made by dissolving carnosic acid, carnosol or rosmarinic acid or any combination thereof in sufficient hop oil to effect complete dissolution. The compositions are added to beer, post-fermentation to provide beers with enhanced flavor and flavor stability. The compositions of this example are combined with hop bitter acids and added to beer post-fermentation to provide beers with enhanced flavor and flavor stability. Additives such as ethanol, glycerin and propylene glycol can be used to enhance the solubility of the compositions of this example.

### EXAMPLE 17

### Labiatae Herb Extracts Extend Flavor in Coffee Extracts

Coffee flavor extracts are prepared by methods commonly used in the art. The coffee flavor extracts are treated with Labiatae herb extracts or constituents isolated from Labiatae herbs. The treated samples show improved flavor stability over untreated controls. The lipophilic, or more oil soluble extracts or constituents are surprisingly efficacious in preserving fresh coffee flavor.

### EXAMPLE 18

### The Effect of Carnosic and Rosmarinic Acids on phenylacetaldehyde and 3-methylbutanal Formation as an Indicator of Aging

The highly hopped beer from example 2 was treated with solutions of carnosic acid in ethanol, rosmarinic acid in ethanol or a mixture of carnosic acid and rosmarinic acid in ethanol as done previously. The preparations were:
1. “Fresh”, in which the beer remained unopened and was stored in the cold room at 2-4° C.
2. “20 ppm CA” in which bottles were opened and 20 ppm carnosic acid was added from a 2% solution of pure CA (355 pL of the 2% solution). The bottles were fobbed to exclude air and crowned.
3. “20 ppm CA+air” in which bottles were opened and 20 ppm CA added as above. These bottles received two puffs of air in the remaining headspace from a 25 mL bulb. They were crowned without fobbing
4. “20 ppm RA” in which bottles were opened and 20 ppm rosmarinic acid added from a 2% solution. The bottles were fobbed and crowned.
5. “20 ppm RA+air” which was done as in No. 4, with 20 ppm RA added. These bottles received the two puffs of air and were crowned without fobbing.
6. “10 ppm RA+10 ppm CA” in which bottles were opened and 10 ppm each of carnosic and rosmarinic acids were added from pure solutions (178 μL of 2% solution per 12 oz bottle). Bottles were fobbed and crowned.
7. “10 ppm RA+10 ppm CA+air” in which 10 ppm each of RA and CA was added. This treatment received two puffs of air and was not fobbed before closing.
8. “Control+air” in which bottles were opened, given two puffs of air and crowned without fobbing.
9. “Control” in which bottles were opened, fobbed and crowned.

Treatments 2 through 9 were stored in a 40° C. hot room. At various times, bottles were opened and samples analyzed for phenylacetaldehyde and 3-methylbutanal by the method of “Vesely, et al. The results are shown in Table 19.

TABLE 19
Parts per million of Phenylacetaldehyde and 3-Methylbutanal in the
headspace of aged beer. Effect of Carnosic Acid, Rosmarinic Acid and Air.

| | | | | | | | | | |
|---|---|---|---|---|---|---|---|---|---|
| | | | | | | 10 ppm | 10 ppm | | |
| | | 20 ppm | 20 ppm | 20 ppm | 20 ppm | RA + 10 ppm | RA + 10 ppm | | |
| Day | fresh | CA | CA + air | RA | RA + air | CA | CA + air | Control + air | Control |

Phenylacetaldehyde

| | | | | | | | | | |
|---|---|---|---|---|---|---|---|---|---|
| 0 | 30.43 | 32.76 | 30.49 | 43.6 | 50.16 | 40.45 | 41.89 | 35.61 | 44.3 |
| 3 | 39.33 | 46.34 | 42.05 | 45.83 | 48.83 | 43.02 | 41.38 | 40.76 | 37.94 |
| 7 | 37.31 | 57.39 | 63.82 | 46.01 | 66.68 | 33.37 | 59.19 | 131.89 | 55.31 |
| 14 | 11.03 | 24.75 | 25.74 | 52.71 | 55.65 | 32.8 | 40.12 | 172.48 | 44.37 |
| 21 | 29.24 | 52.94 | 88.86 | 52.14 | 68.89 | 74.07 | 89.52 | 187.96 | 53.83 |

3-Methylbutanal

| | | | | | | | | | |
|---|---|---|---|---|---|---|---|---|---|
| 0 | 2.92 | 3.24 | 3.44 | 4.12 | 3.13 | 3.52 | 3.17 | 3.14 | 3.88 |
| 3 | 2.91 | 3.13 | 3.85 | 3.05 | 4.14 | 2.99 | 3.01 | 3.94 | 3.65 |
| 7 | 2.06 | 2.98 | 3.68 | 2.73 | 3.95 | 2.8 | 3.11 | 6.29 | 3.91 |
| 14 | 1.46 | 1.82 | 3.45 | 3.03 | 4.28 | 2.91 | 3.28 | 17.83 | 4 |
| 21 | 2.31 | 4.66 | 5.09 | 4.85 | 5.06 | 4.08 | 4.85 | 18.52 | 1.57 |

This example shows that both CA and RA have a dramatic effect in decreasing the formation of these off-flavor compounds in beer.

### EXAMPLE 19

### Effect of Labiatae Herb Compounds on Haze Formation in Aged Beer

The samples prepared in Example 18 were analyzed for haze in the following manner. A clean, dry, clear flint bottle was marked with a permanent mark on the neck for aligning the bottle the same way for each measurement. The bottle was filled with distilled water to the bottom of the neck and aligned in a Haze Meter with the alignment mark facing forward (Haze Meter, Type UKM1d, Radiometer Copenhagen) to zero the instrument. The bottle was emptied and then filled with a degassed beer sample to be tested and the haze was recorded in ASBC Formazin units. The results are shown in Table 20.

TABLE 20
Effect of Labiatae herb compounds on haze formation in aged beer.
Haze (in ASBC Formazin Units)

| | | | | | | 10 ppm | 10 ppm | | |
|---|---|---|---|---|---|---|---|---|---|
| | | 20 ppm | 20 ppm | 20 ppm | 20 ppm | RA + 10 ppm | RA + 10 ppm | | |
| Day | fresh | CA | CA + air | RA | RA + air | CA | CA + air | Control + air | Control |
| 0 | 30 | 40 | 40 | 37 | 37 | 37 | 37 | 40 | 37 |
| 3 | 39 | 30 | 45 | 40 | 32 | 32 | 44 | 90 | 29 |
| 7 | 37 | 35 | 50 | 35 | 40 | 40 | 50 | 120 | 40 |
| 14 | 11 | 45 | 80 | 40 | 100 | 40 | 50 | — | 45 |
| 21 | 29 | 75 | 120 | 55 | 175 | 50 | 180 | 230 | 55 |
| 28 | — | — | — | — | — | — | — | 720 | — |
| 35 | 29 | 110 | 800 | 120 | 800 | 110 | 800 | — | 110 |

This experiment shows that CA and RA have a dramatic positive effect on reducing the rate of haze formation in aged beer that has been exposed to air. It also shows that CA and RA do not increase the amount of haze that is formed in aged beer that has been properly packaged and protected from air. CN will have the same dramatic effect.

### EXAMPLE 20

### Showing the Preserving Effect of Labiatae Herb Compounds in Flavored Malt Beverages

To a flavored malt beverage 10 ppm CA and 5 ppm CN, is added, and the beverage aged. To the same beverage, 10 ppm RA is added. The beverage stabilized with CA and CN will be more flavor stable than that treated with RA, which is only slightly better than the control by flavor evaluation and instrumental analysis. When RA is added to the CA and or CN, an improvement is observed.

### EXAMPLE 21

### Measurement of Flavor Stability Improvement in Aged Citrus Flavored Beverage Treated with Carnosic Acid and Rosmarinic Acid

Beverage Preparation

Carbon filtered water was carbonated to 3.5 to 4 times the volume of beer. Sugar syrup was made by combining the type and listed amounts of ingredients shown in Table 21. 59.2 ml of syrup was added to each 355 ml bottle. Each bottle was individually dosed with the treatments listed in Table 22 by adding 1.775 mL of a 1% (weight/volume) solution of carnosol or rosmarinic acid in ethanol to give 50 ppm of each. The bottle was filled to approximately 355 ml with carbonated water before it was capped and inverted.

TABLE 21
An outline of ingredients used in sugar syrup

| | Amount | Target |
|---|---|---|
| Ingredient (Source) | used in syrup | amount in finished product |
| Sugar (grocery store) | 2.4 kg | 5.2% |
| Saccharin Sodium Salt | 4.8 g | 100 ppm |
| Hydrate, 98% (Aldrich) | | |
| Citric acid, 99.5+% (Aldrich) | 104 g | 0.25% |
| Sodium Benzoate (Noveon | 8 g | 170 ppm |
| Kalama) | | |
| Carbon filtered water | 5.2 kg | 94.4% |
| Limonene, 97+% (Aldrich) | 0.315 g | 5 ppm |
| Citral, 95+% (Aldrich) | 0.319 g | 5 ppm |
| pinene, 97+% (Aldrich) | 0.316 g | 5 ppm |
| Myrcene, 90+% (Aldrich) | 0.076 g | 1 ppm |
| terpinene, 95+% (Aldrich) | 0.150 g | 2 ppm |

TABLE 22
An outline of antioxidant treatments used

| Antioxidant (Source) | Amount of Antioxidant Added |
|---|---|
| Control | 0 |
| Carnosic Acid (Bridge Organics) | 50 ppm CA |
| Rosmarinic Acid (Furfural) | 50 ppm RA |
| Carnosic Acid (CA) + Rosmarinic Acid | 50 ppm CA + 50 ppm RA |
| (RA) | |

Fresh samples were stored in the refrigerator (0° C.). Heat exposed samples were aged in the oven (32° C.) for seven days.

Sensory Triangle Evaluations

Blind triangle panels were conducted with a panel (n20 panelists). Each panel was balanced, with half of the panel given control as the odd sample, the other half of the panel given a treated sample as the odd sample. Panelists were allowed to drink water during the panel.

Sensory Triangle Results

A sensory panel detected no significant difference in fresh untreated samples vs. fresh treated control. After the samples had been aged for 7 days, the sensory panel was able to detect a significant difference with a 95% confidence level between untreated samples and the RA treatment and the CA+RA treatment. Results from the sensory panels are summarized in Table 23. Sample sets in bold are significantly different with a 95% confidence level. The triangle data shows significant differences, but fails to give us the direction of those differences. Another panel was conducted such as those used in the beer panel to determine the amount of flavor loss or staling in the model citrus beverage.

TABLE 23
Sensory results for model citrus beverage panels.

| | Correct Panelists/ |
|---|---|
| Samples Presented | Total Panelists |
| Fresh Control vs. Fresh CA | 9/20 |
| Fresh Control vs. Fresh RA | 10/22 |
| Aged Control vs. Aged CA | 9/21 |
| Aged Control vs. Aged RA | 12/20 |
| Aged Control vs. Aged CA + RA | 11/20 |
| Aged Control vs. Fresh Control | 15/22 |
| Fresh Control vs. Aged RA | 12/21 |
| Fresh Control vs. Aged CA + RA | 16/20 |

Scaling Sensory Panel for Differences in Citrus Beverage Scaling

The sensory data were taken in the following manner. Each sample (controls and treatments) was presented to the panelists one time. Panelists rated the beers on a scale of 0-10, with 0 being fresh and 10 being most stale. Panelists were given examples of a fresh and stale material prior to the panel for training on these characteristics. Since the output of the panel as a whole was desired, and not any one individual panelist, the means of each treatment sample in each replicate groups were calculated and tabulated as in Table 24. Samples were prepared and evaluated blindly as part of the sample set were fresh controls diluted by a factor of 2 and 4. These diluted samples best represent the loss in flavor that occurs when the sample is thermally aged. Any panelist not getting the 1) aged control vs. the fresh control, followed by 2) the 2× and 4× dilutions ranked in the right order had their data removed from the analysis, since it indicated that they were not performing well for that attribute in that session.

Statistical analysis consisted of doing paired t-Tests on the treatment sample vs. the aged control sample (Table 25). One-tailed tests were used that probed the question whether the staling values of one treatment were lower than that of the other (e.g treatment vs. control). Confidence levels were reported along with p values.

TABLE 24
Panelist averages for model citrus beverage.

| Panelist | Average |
|---|---|
| Fresh RA | 0.67 |
| Fresh Control | 1.50 |
| Fresh RA/CA | 1.83 |
| Aged RA/CA | 3.67 |
| ½ strength Fresh Control | 3.67 |
| Aged Control | 5.17 |
| Aged RA | 6.17 |
| ¼ strength Fresh Control | 6.50 |

Note in Table 24 that the Aged RA/CA was equivalent to the ½ strength fresh control and the aged control was about half-way between the ½ strength control and the ¼ strength control. Also note that the Fresh RA/CA was not statistically different from the Fresh Control (See Table 25). Therefore the starting points were the same, but the end points were different.

TABLE 25
Comparison of citrus beverage scaling panel
results using paired t-test.

| | Confidence | p |
|---|---|---|
| Sample | Level | Value |
| Aged Control vs. Fresh Control | 99.76% | 0.0024 |
| Aged RA/CA vs. Aged Control | 99.14% | 0.0086 |
| Fresh RA/CA vs. Fresh Control | 65.24% | 0.3476 |

Conclusion

Although all the Labiatae herb compounds are shown to protect the beer from flavor degradation, it is clear from the examples that a given compound may or may not be effective in maintaining redox potential at a given stage in the brewing process, and yet all compounds do maintain redox potential at one or more stages. These confusing results, all of which are positive in terms of the beer, are consistent with the inability of the art to agree on the best method of preserving flavor, and the mechanisms by which it degrades. Furthermore, these results shed no light on the mechanisms of beer staling, since the active compounds behave so differently.

Although there are prior art references teaching the use of rosmarinic acid to stabilize the flavor of citrus beverages, the references do not teach or suggest that more oil soluble antioxidant constituents of the Labiatae herbs are useful in this regard. The very different behavior and effect of rosmarinic acid vs. the more oil soluble constituents, carnosic acid and carnosol, make it impossible to know a priori that these materials would have a beneficial effect on the flavor stability of citrus, fruit, berry and cola flavored still soft drinks and carbonated beverages.

The present invention is not to be limited in scope by the specific embodiments described herein. Indeed, various modifications of the invention in addition to those described herein will become apparent to those skilled in the art from the foregoing description.

All patents, applications, publications, test methods, literature, and other materials cited herein are hereby incorporated by reference.

Literature References

Ames, J. L., 2001, “Melanoidins as Pro- or Antioxidants,” Cerevisia 26(4), 210-216.

Back, W., C. Forster, M. Kratienthaler, J. Lehmann, B. Sacher and B. Thum, 1999, “New Research Findings on Improving Taste Stability,” Brauwelt Int., 394-405.

Bamforth, C. W., 2000, “Making Sense of Flavor Change in Beer,” Proc. Cong.—Eur. Brew. Conv., 37(2), 165-171.

Burroughs, L. J. and P. D. Williams, 1999, “A single HPLC Method for Complete Separation of Unmodified and Reduced Iso-Alpha Acids” Proceedings of the European Brewery Convention Congress, 27, 283-290.

Da dic, M. 1984, “Beer Stability—A Key to Success in Brewing,” Tech. Q. Master Brew. Assoc. Am., 21(1): 9-26.

De Cooman, L., G. Aerts, H. Overmeire and D. De Keukeleire, 2000, “Alterations of the Profiles of Iso-alpha-Acids During Beer Aging, Marked Instability of Trans-Iso-alpha acids and Implications for Beer Bitterness Consistency in relation to Tetrahydroiso-alpha-acids, J. Inst. Brew. 106(3), 169-178.

Huige, N. J., 1993, “Progress in Beer Oxidation Control, in YYYYYY ACS, pp. 64-97.

Vesely, P., L. Lusk, G. Basarova, J. Seabrooks, and D. Ryder, “Analysis of Strecker Aldehydes in Beer during Storage Using SPME with On-fiber Derivatization” Institute of Chemical Technology, Technicka 5, Prague 6, 166 28, Czech Republic. Poster presented at the EBC 2003, Dublin Ireland, 2003.

Walters, M. T., A. P. Heasman and P.S. Hughes, 1997, “Comparison of (+)-Catechin and Ferulic Acid as Natural Antitoxidants and their impact on Beer Flavor Stability. Part 2: Extended Storage Trials, J. AM. Soc. Brew. Chem. 55(3): 91-98.

Walters, M. T., A. P. Heasman P. S. Hughes, 1997, “Comparison of (+)-Catechin and Ferulic Acid as Natural Antitoxidants and their impact on Beer Flavor Stability. Part 1: Forced Aging., J. AM. Soc. Brew. Chem. 55(2): 83-89.

1. A method for enhancing the stability of a beverage, comprising addition of Labiatae herb extracts or constituents of Labiatae herbs, optionally formulated in a food grade carrier, to the beverage or to some point in its manufacture.

2. The method of claim 1, wherein the beverage is selected from malt beverages, beer, ale, dry beer, near beer, light beer, low alcohol beer, low calorie beer, porter, bock beer, stout, malt liquor, non-alcoholic malt beverages, and beer in which the alcohol has been removed.

3. The method of claim 1, wherein the beverage is selected from coffee, flavored coffees, fortified soft drinks, energy drinks, citrus drinks, fruit drinks, berry and cola flavored still soft drinks and carbonated beverages, fruit juices, and flavored malt beverages.

4. The method of claim 1, wherein the Labiatae herb extract comprises a crude Labiatae herb extract, carnosic acid and mixtures of carnosic acid, carnosol, and rosmarinic acid.

5. The method of claim 1 for enhancing flavor stability of malt beverages and beer comprising addition of a Labiatae herb extract to the beer or malt beverage.

6. The method of claim 5, wherein the Labiatae herb extract comprises a crude Labiatae herb extract, carnosic acid and mixtures of carnosic acid, carnosol, and rosmarinic acid.

7. The method of claim 1 for enhancing flavor stability of malt beverages and beer comprising addition of a Labiatae herb extract during beer manufacture.

8. The method of claim 7, wherein the Labiatae herb extract comprises a crude Labiatae herb extract, carnosic acid and mixtures of carnosic acid, carnosol, and rosmarinic acid.

9. The method of claim 7, wherein the Labiatae herb extract is added at one or more stages of malt beverage or beer manufacture selected from
to cereal grains prior to the malting process,
to cereal grains during the malting process,
prior to the mashing process,
during the mashing process,
prior to the lautering process,
during the lautering process,
prior to the wort boil,
during the wort boil,
just prior to the fermenting process,
during the fermenting process, and
after fermentation.

10. The method of claim 9 for enhancing flavor stability of malt beverages and beer comprising addition of rosmarinic acid in any or all of the stages of beverage manufacture prior to wort boil and/or addition of carnosic acid and/or carnosol to any or all of the stages of beverage manufacture during or after wort boil.

11. The method of claim 9 for enhancing flavor stability of malt beverages and beer comprising addition of rosmarinic acid in any or all of the beverage manufacture steps prior to wort boil.

12. The method of claim 9 for enhancing the flavor stability of malt beverages and beer comprising addition of carnosic acid and/or carnosol to any or all of the stages of beverage manufacture during or after wort boil.

13. The method of claim 1 for enhancing redox potential of malt beverages or beer comprising addition of Labiatae herb extracts to any or all of the stages of manufacture.

14. The method of claim 13 for enhancing redox potential of malt beverages or beer comprising addition of rosmarinic acid to any or all of the stages of manufacture.

15. The method of claim 13 for enhancing redox potential of mash comprising addition of Labiatae herb extracts prior to the mashing process, malting process, kilning process, or a combination thereof.

16. The method claim 13 for enhancing redox potential of mash comprising addition of rosmarinic acid prior to the formation of mash from malted grains.

17. The method of claim 13 for enhancing the redox potential of mash comprising addition of rosmarinic acid during the formation of mash from malted grains.

18. The method of claim 13 for enhancing redox potential of malt beverages or beer comprising addition of carnosic acid to any or all of the stages of manufacture.

19. The method of claim 13 for enhancing redox potential of malt beverages or beer comprising addition of carnosic acid to the beverage after fermentation.

20. The method of claim 1 for minimizing the loss of redox potential of malt beverages and beer during the pasteurization process comprising addition of carnosic acid and/or carnosol to any stage of manufacture from and including wort boil to immediately prior to the pasteurization step.

21. The method of claim 1 for preserving hop bitter acids in malt beverages and beer upon storage, comprising addition of carnosic acid or a mixture of carnosic acid and rosmarinic acid to finished malt beverage or beer or to any stage in the manufacture of the malt beverage or beer.

22. The method of claim 21 wherein the rate of change in the ratio of cis to trans isohumulones or reduced isohumulones is reduced.

23. The method of claim 1 for preserving malt beverage or beer color during storage, comprising addition of carnosic acid or a mixture of carnosic acid and rosmarinic acid to the beverage or to any stage in the manufacture of the beverage.

24. The method of claim 1 for preserving the redox potential of a malt beverage or beer which has been exposed to injurious levels of oxygen comprising addition of carnosic acid, rosmarinic acid, and/or mixtures thereof to a step in the manufacture of the beverage.

25. The method of claim 1 for delaying haze formation in aged malt beverages or beers comprising addition of carnosic acid, rosmarinic acid, and/or mixtures thereof to the beverage.

26. The method of claim 25, wherein the aged malt beverage or beer has been exposed to injurious levels of oxygen.

27. The method of claim 1 for delaying the formation of hop and/or malt degradation products in aged or thermally abused malt beverage or beer comprising addition of carnosic acid, rosmarinic acid, and/or mixtures thereof to the malt beverage or beer either before during or after manufacture.

28. The method of claim 27 wherein the hop and/or malt degradation products are selected from volatile carbonyl compounds, trans-2-nonenal, phenylacetaldehyde and 3-methylbutanal.

29. The method of claim 1 for protecting the natural melanoidins, polyphenols, and sulfites in a malt beverage or beer comprising addition of a Labiatae herb extract before or during manufacture or both before and during manufacture.

30. The method of claim 1 for protecting against oxidative phenomena comprising addition of a Labiatae herb extract before or during malt beverage or beer manufacture or both before and during manufacture.

31. The method of claim 1 for protecting against lipid hydroperoxides during the mashing step of malt beverage or beer manufacture comprising addition of a Labiatae herb extract before or during manufacture or both before and during manufacture.

32. The method of claim 1, wherein the Labiatae herb extract is provided below the flavor threshold.

33. The method of claim 1, wherein the Labiatae herb extract is formulated in a food grade carrier comprising propylene glycol, ethanol, water, monoglycerides of fatty acids, diglycerides of fatty acids or glycerin, or mixtures thereof.
